(19) United States
(12) Patent Application Publication
(10) Pub. No.: US 2024/0204834 A1
(43) Pub. Date: Jun. 20, 2024

(54) PRECODING MATRIX INDICATOR FEEDBACK METHOD AND COMMUNICATION APPARATUS

(71) Applicant: Huawei Technologies Co., Ltd., Shenzhen (CN)

(72) Inventors: Shengyu Li, Beijing (CN); Lei Guan, Beijing (CN)

(21) Appl. No.: 18/432,796

(22) Filed: Feb. 5, 2024

Related U.S. Application Data
(63) Continuation of application No. PCT/CN2022/103986, filed on Jul. 5, 2022.

(30) Foreign Application Priority Data
Aug. 6, 2021 (CN) 202110904275.8

(51) Int. Cl. H04B 7/0456

(52) U.S. Cl. CPC H04B 7/0469

(57) ABSTRACT

This application provides a precoding matrix indicator feedback method and a communication apparatus, and relates to the field of communication technologies. The method is applied to a precoding process, and specifically includes: A terminal first determines a first PMI, and then sends the first PMI to an access network device. The first PMI indicates a precoding matrix W. The precoding matrix W includes R precoding vectors wᵢ, where i=0,1,2, . . . , R−1. The precoding vector wᵢ is a column vector with a length of N₁×N₂×N_{g}. N_{g} represents a quantity of antenna panels. N₁ represents a quantity of ports in a first dimension on one antenna panel. N₂ represents a quantity of ports in a second dimension on the antenna panel. N₁, N₂ and N_{g} are all positive integers, and at least one of N₁, N₂, and N_{g} is greater than or equal to 2.

### CROSS-REFERENCE TO RELATED APPLICATIONS

This application is a continuation of International Application No. PCT/CN2022/103986, filed on Jul. 5, 2022, which claims priority to Chinese Patent Application No. 202110904275.8, filed on Aug. 6, 2021. The disclosures of the aforementioned applications are hereby incorporated by reference in their entireties.

### TECHNICAL FIELD

This application relates to the field of wireless communication technologies, and in particular, to a precoding matrix indicator feedback method and a communication apparatus.

### BACKGROUND

In a massive multiple-input multiple-output (Massive MIMO) system, a terminal and an access network device share one codebook. For downlink data transmission, the terminal first determines wireless channel information and interference information through channel estimation, selects a precoding matrix from the codebook based on the wireless channel information and the interference information, and feeds back a precoding matrix indicator (PMI) that corresponds to the precoding matrix and a corresponding channel quality indicator (CQI) to the access network device. The access network device restores the precoding matrix based on the PMI and the codebook, performs precoding processing based on a restored precoding matrix, and selects a modulation order and a coding rate of downlink data based on the CQI that is fed back. Therefore, system transmission performance is improved.

### SUMMARY

This application provides a precoding matrix indicator feedback method and a communication apparatus, so that a PMI that matches a single-polarized antenna array can be fed back.

To achieve the foregoing objective, the following technical solutions are used in embodiments of this application.

According to a first aspect, a precoding matrix indicator feedback method is provided. A terminal determines a first precoding matrix indicator PMI. The first PMI indicates a precoding matrix W. The precoding matrix W includes R precoding vectors wᵢ, where i=0,1,2, . . . , R−1. The precoding vector wᵢ is a column vector with a length of N₁×N₂×N_{g}. N_{g} represents a quantity of antenna panels. N₁ represents a quantity of ports in a first dimension on one antenna panel. N₂ represents a quantity of ports in a second dimension on the antenna panel. N₁, N₂, and N_{g} are all positive integers, and at least one of N₁, N₂, and N_{g} is greater than or equal to 2. Then, the terminal sends the first PMI to an access network device. Correspondingly, the access network device receives the first PMI from the terminal.

In the precoding matrix indicator feedback method in this embodiment of this application, the precoding matrix W indicated by the first PMI includes the R precoding vectors wᵢ, and the precoding vector wᵢ is the column vector with the length of N₁×N₂×N_{g}. In other words, the precoding matrix W indicated by the first PMI includes a precoding vector in a polarization direction, and matches an antenna array in a single-polarized design. In this way, the terminal can feed back, to the access network device, the first PMI that matches the single-polarized antenna array.

In a possible design, the access network device sends first configuration information to the terminal. Correspondingly, the terminal receives the first configuration information. The first configuration information indicates that a quantity of ports of a reference signal RS is N₁×N₂×N_{g}. A measurement result of the RS is used to determine the first PMI.

When the access network device determines that the antenna array is deployed in a single-polarized manner, to reduce reference signal overheads, the quantity of ports of the reference signal usually sent by the access network device corresponds to a quantity of ports in a polarization direction, that is, the quantity is N₁×N₂×N_{g}. In this case, the terminal can determine, based on the reference signal, an antenna port in only one polarization direction. If the terminal feeds back a PMI based on an existing dual-polarized codebook and an assumption that the antenna array is deployed in a dual-polarized manner, a precoding matrix that is fed back may not match a channel feature of the antenna port in the actual antenna array deployed in the single-polarized manner, and feedback accuracy is reduced. In this embodiment of this application, the terminal determines, based on the quantity of ports of the RS and an antenna array configuration manner, that the antenna array is deployed in the single-polarized manner. In this way, the precoding matrix indicated by the first PMI that is fed back by the terminal is quantized based on the channel feature in deployment of the single-polarized antenna array, to improve the feedback accuracy.

In a possible design, the access network device sends first indication information to the terminal. Correspondingly, the terminal receives the first indication information. The first indication information indicates a single-polarized PMI feedback manner, and the single-polarized PMI feedback manner is used to determine the first PMI.

For example, when sending the reference signal, the access network device still correspondingly sends a reference signal for all ports in deployment of a dual-polarized antenna array. Then, the access network device indicates, based on the first indication information, that the terminal feeds back a single-polarized precoding matrix. In other words, the first indication information indicates that the terminal uses the single-polarized PMI feedback manner to determine the first PMI. In this case, if the terminal still feeds back a PMI that indicates a dual-polarized precoding matrix, that is, a quantity of ports of the precoding matrix indicated by the PMI that is fed back is 2×N₁×N₂×N_{g}, offset value information between two polarization directions needs to be additionally fed back. Consequently, the feedback overheads are increased. However, in this embodiment of this application, when the terminal feeds back the first PMI, the terminal determines, based on the first indication information, that the single-polarized PMI feedback manner is used to determine the first PMI, that is, the PMI that indicates the single-polarized precoding matrix needs to be fed back. In this way, the precoding matrix indicated by the first PMI that is fed back by the terminal is fed back based on a channel feature in a polarization direction of the port of the reference signal, to reduce quantization overheads and the feedback overheads.

In a possible design, the access network device sends second indication information to the terminal. Correspondingly, the terminal receives the second indication information. The second indication information indicates a polarization direction, and the polarization direction is used to determine the first PMI. The terminal may determine a polarization direction based on the second indication information from the access network device, where precoding matrix quantization is performed on the first PMI based on a measurement channel feature of a port in the polarization direction in a reference signal. Therefore, it is ensured that the precoding matrix indicated by the first PMI matches the port that is in the polarization direction and that is expected by the access network device for using, and transmission efficiency is improved.

In a possible design, N_{g}=1. The precoding vector wᵢ is a two-dimensional discrete Fourier transform DFT vector. The two-dimensional DFT vector satisfies:

$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix}$$

νₗ_{ᵢ}_{,m}_{ᵢ} represents a two-dimensional DFT vector. (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1. O₁ represents an oversampling factor in the first dimension. O₂ represents an oversampling factor in the second dimension. The first PMI is used to determine (lᵢ, mᵢ).

In a possible design, N_{g}>1. The precoding vector wᵢ satisfies:

wᵢ=[w_{i,0}; w_{i,1}; . . . ; w_{i,N}_{_{g}}₋₁]

The sub-vector w_{i,0} is the 1^{st} sub-vector in the precoding vector wᵢ. The sub-vector w_{i,0} is a two-dimensional DFT vector, and the two-dimensional DFT vector satisfies:

$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix}$$

νₗ_{ᵢ}_{,m}_{ᵢ} represents the two-dimensional DFT vector. (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1. O₁ represents an oversampling factor in the first dimension. O₂ represents an oversampling factor in the second dimension.

The sub-vector w_{i,g} is the (g+1)^{th} sub-vector in the precoding vector wᵢ, and the sub-vector w_{i,g} satisfies:

w_{i,g}=α_{g}w_{i,0}

g=1,2, . . . , N_{g}−1. α_{g} is an offset value of the (g+1)^{th} sub-vector w_{i,g} relative to the 1^{st} sub-vector w_{i,0}.

The first PMI is used to determine (lᵢ, mᵢ) and the offset value α_{g}.

In other words, in a Type-1 single panel codebook and a Type-1 multi-panel codebook, the precoding matrix W indicated by the first PMI includes the precoding vector in the polarization direction. In comparison with a Type-1 codebook that matches the dual-polarized antenna array, the precoding matrix W indicated by the first PMI does not include a precoding vector in another polarization direction. Therefore, the feedback overheads can be reduced. In addition, the precoding matrix indicated by the first PMI is quantized and fed back based on the deployment of the single-polarized antenna array. In comparison with feedback accuracy in a case in which a dual-polarized codebook is fed back based on an antenna array that is deployed in the dual-polarized manner and that has a same quantity of ports, the feedback accuracy of embodiments of this application is higher.

In a possible design, the precoding vector wa is a linear weight of S two-dimensional DFT vectors. The precoding vector wᵢ satisfies:

wᵢ=Σₛ₌₀^{S-1}β_{i,s}νₗ_{ₛ}_{,m}_{ₛ}

β_{i,s} is a combination coefficient of the precoding vector wᵢ on the S two-dimensional DFT vectors. νₗ_{ₛ}_{,m}_{ₛ} represents the (s+1)^{th} two-dimensional DFT vector in the S two-dimensional DFT vectors, and the (s+1)^{th} two-dimensional DFT vector νₗ_{ₛ}_{,m}_{ₛ} satisfies:

$$\{ \begin{matrix}{v}_{{l}_{s} , {m}_{s}} = {[ {u}_{{m}_{s}} , {u}_{{m}_{s}} {e}^{j \frac{2 π {l}_{s}}{{O}_{1} {N}_{1}}} , … , {u}_{{m}_{s}} {e}^{j \frac{2 π {l}_{s} ( {N}_{1} - 1 )}{{O}_{1} {N}_{1}}} ]}^{T} \\ {u}_{{m}_{s}} = [ 1 , {e}^{j \frac{2 π {m}_{s}}{{O}_{2} {N}_{2}}} , … , {e}^{j \frac{2 π {m}_{s} ( {N}_{2} - 1 )}{{O}_{2} {N}_{2}}} ]\end{matrix}$$

(lₛ, mₛ) respectively represents an index of the (s+1)^{th} two-dimensional DFT vector in the first dimension and an index of the (s+1)^{th} two-dimensional DFT vector in the second dimension, lₛ=0,1, . . . , O₁N₁−1, and mₛ=0,1, . . . , O₂N₂−1. O₁ represents an oversampling factor in the first dimension. O₂ represents an oversampling factor in the second dimension, and S is an integer of greater than or equal to 2. The first PMI is used to determine (lₛ, mₛ) and the combination coefficient β_{i,s}.

In a possible design, the precoding vector wᵢ is a linear weight of S unit vectors. The precoding vector wᵢ satisfies:

wᵢ=Σₛ₌₀^{S-1}β_{i,s}νₗ_{ₛ}

β_{i,s} is a combination coefficient of the precoding vector wᵢ on the S unit vectors. vₗ_{ₛ} is a column vector with a length of N₁×N₂, where the (lₛ+1)^{th} element is 1, and other elements are 0. lₛ represents an index of vₗ_{ₛ}, and lₛ=0,1, . . . , S−1. S is an integer greater than or equal to 2. The first PMI is used to determine the index lₛ and the combination coefficient β_{i,s}.

In a process of determining a Type-2 codebook of a dual-polarized antenna array or a Type-2 port selection codebook of a dual-polarized antenna array, indexes of S base vectors and a combination coefficient of precoding vectors corresponding to ports in two polarization directions need to be first determined. However, in embodiments of this application, only the indexes lₛ of the S base vectors and the combination coefficient β_{i,s} of the precoding vector that corresponds to a port in one polarization direction need to be determined for determining the first PMI. Therefore, implementation complexity and processing load of the terminal are reduced.

In a possible design, the first PMI is carried in a first CSI report, and the first CSI report does not include a second PMI. The second PMI and the first PMI jointly indicate a precoding matrix W_{dual}. The precoding matrix W_{dual} includes R precoding vectors w_{dual,i}, w_{dual,i}=[wᵢ, \tilde{w}ᵢ], and i=0,1,2, . . . , R−1. The precoding vectors wᵢ and \tilde{w}ᵢ are column vectors with a length of N₁×N₂×N_{g}. The precoding vector wi represents a precoding vector in a first polarization direction. The precoding vector \tilde{w}ᵢ represents a precoding vector in a second polarization direction.

In other words, the first PMI indicates a precoding matrix in a polarization direction.

In a possible design, the first PMI is carried in a first CSI report. The first PMI is a single-polarized PMI. The first CSI report further includes a third PMI. The third PMI is a dual-polarized PMI. The third PMI indicates a precoding matrix W′_{dual}. The precoding matrix W′_{dual} includes R′_{dual} precoding vectors w′_{dual,i}, and i=0, 1, 2, . . . , R′_{dual}−1. The precoding vector w′_{dual,i} is a column vector with a length of 2×N₁×N₂×N_{g}.

In other words, when the access network device expects to obtain both the precoding matrix in the deployment of the single-polarized antenna array and the precoding matrix in the deployment of the dual-polarized antenna array, the access network device may indicate to report a plurality of pieces of CSI in one CSI report. Different CSI corresponds to different antenna array deployment manners. The configuration manner can enable two pieces of CSI to share a downlink reference signal, and reduce pilot overheads of the downlink reference signal.

In a possible design, the first PMI is carried on an uplink physical channel, for example, a physical uplink control channel PUCCH or a physical uplink shared channel PUSCH.

According to a second aspect, a communication apparatus is provided. The communication apparatus may be a terminal in any one of the first aspect or the possible designs of the first aspect, or a chip that implements a function of the terminal. The communication apparatus includes a corresponding module, a unit, or a means that implements the method. The module, the unit, or the means may be implemented by hardware, software, or hardware executing corresponding software. The hardware or the software includes one or more modules or units corresponding to the foregoing functions.

The communication apparatus includes a processing unit and a transceiver unit. The processing unit is configured to determine a first precoding matrix indicator PMI. The first PMI indicates a precoding matrix W. The precoding matrix W includes R precoding vectors wᵢ, where i=0,1,2, . . . , R−1. The precoding vector wᵢ is a column vector with a length of N₁×N₂×N_{g}. N_{g} represents a quantity of antenna panels. N₁ represents a quantity of ports in a first dimension on one antenna panel. N₂ represents a quantity of ports in a second dimension on the antenna panel. N₁, N₂, and N_{g} are all positive integers, and at least one of N₁, N₂, and N_{g} is greater than or equal to 2. The transceiver unit is configured to send the first PMI.

In a possible design, the transceiver unit is further configured to receive first configuration information. The first configuration information indicates that a quantity of ports of a reference signal RS is N₁×N₂×N_{g}, and a measurement result of the RS is used to determine the first PMI.

In a possible design, the transceiver unit is further configured to receive first indication information. The first indication information indicates a single-polarized PMI feedback manner, and the single-polarized PMI feedback manner is used to determine the first PMI.

In a possible design, the transceiver unit is further configured to receive second configuration information. The second indication information indicates a polarization direction, and the polarization direction indicated by the second indication information is used to determine the first PMI.

For a more detailed design of the communication apparatus, refer to related descriptions in the first aspect.

According to a third aspect, a communication apparatus is provided. The communication apparatus may be an access network device in any one of the first aspect or the possible designs of the first aspect, or a chip that implements a function of the access network device. The communication apparatus includes a corresponding module, a unit, or a means that implements the method. The module, the unit, or the means may be implemented by hardware, software, or hardware executing corresponding software. The hardware or the software includes one or more modules or units corresponding to the foregoing functions.

The communication apparatus includes a processing unit and a transceiver unit. The transceiver unit is configured to receive a first precoding matrix indicator PMI. The first PMI indicates a precoding matrix W. The precoding matrix W includes R precoding vectors wᵢ, where i=0,1,2, . . . , R−1. The precoding vector wᵢ is a column vector with a length of N₁×N₂×N_{g}. N_{g} represents a quantity of antenna panels. N₁ represents a quantity of ports in a first dimension on one antenna panel. N₂ represents a quantity of ports in a second dimension on the antenna panel. N₁, N₂, and N_{g} are all positive integers, and at least one of N₁, N₂, and N_{g} is greater than or equal to 2. The processing unit is configured to perform precoding based on the precoding matrix W indicated by the first PMI.

In a possible design, the transceiver unit is further configured to send first configuration information. The first configuration information indicates that a quantity of ports of a reference signal RS is N₁×N₂×N_{g}, and a measurement result of the RS is used to determine the first PMI.

In a possible design, the transceiver unit is further configured to send first indication information. The first indication information indicates a single-polarized PMI feedback manner, and the single-polarized PMI feedback manner is used to determine the first PMI.

In a possible design, the transceiver unit is further configured to send second configuration information. The second indication information indicates a polarization direction, and the polarization direction indicated by the second indication information is used to determine the first PMI.

For a more detailed design of the communication apparatus, refer to related descriptions in the first aspect.

According to a fourth aspect, a communication apparatus is provided, including a processor and a memory. The memory is configured to store computer instructions. When the processor executes the instructions, the communication apparatus is enabled to perform the method that is performed by a terminal in any one of the foregoing aspects or any possible design of the foregoing aspects. The communication apparatus may be a terminal in any one of the first aspect or the possible designs of the first aspect, or a chip that implements a function of the terminal. The communication apparatus may alternatively be an access network device in any one of the first aspect or the possible designs of the first aspect, or a chip that implements a function of the access network device.

According to a fifth aspect, a communication apparatus is provided, including a processor. The processor is coupled to a memory, and is configured to read and execute instructions in the memory, so that the communication apparatus performs a method that is performed by a terminal in any one of the foregoing aspects or any possible design of the foregoing aspects. The communication apparatus may be a terminal in any one of the first aspect or the possible designs of the first aspect, or a chip that implements a function of the terminal. The communication apparatus may alternatively be an access network device in any one of the first aspect or the possible designs of the first aspect, or a chip that implements a function of the access network device.

According to a sixth aspect, a chip is provided, including a processing circuit and an input/output interface. The input/output interface is configured to communicate with a module other than the chip. For example, the chip may be a chip that implements a function of a terminal in any one of the first aspect or the possible designs of the first aspect, or may be a chip that implements a function of an access network device in any one of the first aspect or the possible designs of the first aspect. The processing circuit is configured to run a computer program or instructions, to implement the method in any one of the first aspect or the possible designs of the first aspect.

According to a seventh aspect, a computer-readable storage medium is provided. The computer-readable storage medium stores instructions. When the instructions are executed by a communication apparatus, the communication apparatus can perform the method in any one of the foregoing aspects.

According to an eighth aspect, a computer program product whose type includes instructions is provided. When the computer program product is executed by a communication apparatus, the communication apparatus can perform the method in any one of the foregoing aspects.

According to a ninth aspect, a circuit system is provided. The circuit system includes a processing circuit, and the processing circuit is configured to perform the method in any one of the foregoing aspects.

According to the tenth aspect, a communication system is provided, and the communication system includes a terminal and an access network device in any one of the foregoing aspects.

For technical effects brought by any design of the second aspect to the tenth aspect, refer to beneficial effects brought by the foregoing corresponding methods. Details are not described herein again.

### BRIEF DESCRIPTION OF THE DRAWINGS

FIG. 1 is a schematic diagram of an architecture of a mobile communication system according to an embodiment of this application;

FIG. 2 is a schematic flowchart of a precoding matrix indicator feedback method according to an embodiment of this application;

FIG. 3 is a schematic diagram of a structure of a communication apparatus according to an embodiment of this application; and

FIG. 4 is a schematic diagram of a structure of another communication apparatus according to an embodiment of this application.

### DETAILED DESCRIPTION OF THE EMBODIMENTS

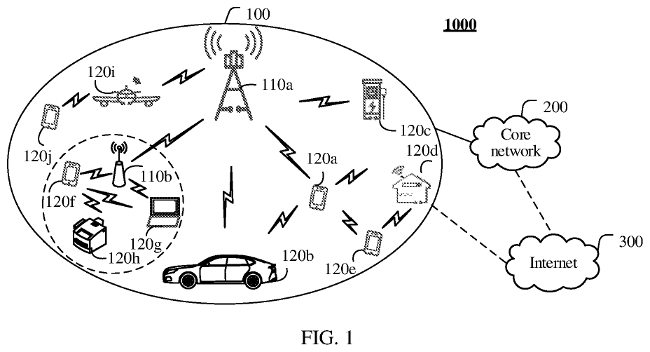

FIG. 1 is a schematic diagram of an architecture of a communication system 1000 to which an embodiment of this application is applied. As shown in FIG. 1, the communication system includes a radio access network 100 and a core network 200. Optionally, the communication system 1000 may further include an Internet 300. The radio access network 100 may include at least one radio access network device (for example, 110a and 110b in FIG. 1), and may further include at least one terminal (for example, 120a to 120j in FIG. 1). The terminal is connected to the radio access network device in a wireless manner, and the radio access network device is connected to the core network in a wireless or wired manner. A core network device and the radio access network device may be different physical devices independent of each other, functions of the core network device and logical functions of the radio access network device may be integrated into a same physical device, or a part of functions of the core network device and a part of functions of the radio access network device may be integrated into one physical device. A wired or wireless manner may be used for connection between terminals and between radio access network devices. FIG. 1 is only a schematic diagram. The communication system may further include another network device, for example, may further include a wireless relay device and a wireless backhaul device, which are not shown in FIG. 1.

The radio access network device may be a base station, an evolved NodeB (eNodeB), a transmission reception point (TRP), a next generation NodeB (gNB) in a 5^{th} generation (5G) mobile communication system, a next generation NodeB in a 6^{th} generation (6G) mobile communication system, a base station in a future mobile communication system, an access node in a Wi-Fi system, or the like; or may be a module or unit that completes some functions of the base station, for example, may be a central unit (CU), or may be a distributed unit (DU). The CU herein completes functions of the radio resource control protocol and the packet data convergence protocol (PDCP) of the base station, and may further complete functions of the service data adaptation protocol (SDAP). The DU completes functions of a radio link control layer and a medium access control (MAC) layer of the base station, and may further complete functions of a part or all of a physical layer. For specific descriptions of the foregoing protocol layers, reference may be made to technical specifications related to the 3^{rd} generation partnership project (3GPP). The radio access network device may be a macro base station (for example, 110a in FIG. 1), or may be a micro base station or an indoor station (for example, 110b in FIG. 1), or may be a relay node, a donor node, or the like. A specific technology and a specific device form used by the radio access network device are not limited in embodiments of this application. In embodiments of this application, the radio access network device may be referred to as an access network device for short, and the base station is a specific example of the access network device.

The terminal may also be referred to as terminal equipment, user equipment (UE), a mobile station, a mobile terminal, or the like. The terminal may be widely used in various scenarios, for example, device-to-device (D2D), vehicle to everything (V2X) communication, machine-type communication (MTC), internet of things (IOT), virtual reality, augmented reality, industrial control, self-driving, telemedicine, smart grid, smart furniture, smart office, smart wearable, smart transportation, smart city, and the like. The terminal may be a mobile phone, a tablet computer, a computer with a wireless transceiver function, a wearable device, a vehicle, an uncrewed aerial vehicle, a helicopter, an airplane, a ship, a robot, a mechanical arm, a smart home device, or the like. A specific technology and a specific device form used by the terminal are not limited in embodiments of this application.

The base station and the terminal may be fixed or movable. The base station and the terminal may be deployed on land, including an indoor or outdoor scenario, and a handheld or an in-vehicle scenario; or may be deployed on water; or may be deployed on an aircraft, a balloon, or an artificial satellite in the air. Application scenarios of the base station and the terminal are not limited in embodiments of this application.

Roles of the base station and the terminal may be opposite, for example, the helicopter or uncrewed aerial vehicle 120i in FIG. 1 may be configured as the mobile base station, and for the terminal 120j accessing the radio access network 100 through 120i, the terminal 120i is the base station. However, for the base station 110a, 120i is the terminal, that is, communication between 110a and 120i is performed by using a wireless air interface protocol. Certainly, communication may also be performed between 110a and 120i by using an interface protocol between base stations. In this case, in comparison with 110a, 120i is also the base station. Therefore, both the base station and the terminal may be collectively referred to as a communication apparatus, 110a and 110b in FIG. 1 may be referred to as a communication apparatus having a function of the base station, and 120a to 120j in FIG. 1 may be referred to as a communication apparatus having a function of the terminal.

Communication between the base station and the terminal, between the base station and the base station, or between the terminal and the terminal may be performed by using a licensed spectrum, or may be performed by using an unlicensed spectrum, or may be performed by using both the licensed spectrum and the unlicensed spectrum. Communication may be performed by using a spectrum below 6 gigahertz (GHz), or may be performed by using a spectrum above 6 GHz, or may be simultaneously performed by using the spectrum below 6 GHz and the spectrum above 6 GHz. A spectrum resource used for wireless communication is not limited in embodiments of this application.

In embodiments of this application, the function of the base station may be performed by a module (for example, a chip) in the base station, or may be performed by a control sub-system including the function of the base station. The control subsystem that includes the function of the base station herein may be a control center in the foregoing application scenarios, such as the smart grid, the industrial control, the intelligent transportation, and the smart city. The function of the terminal may be performed by a module (for example, a chip or a modem) in the terminal, or may be performed by an apparatus including the function of the terminal.

In this application, the base station sends a downlink signal or downlink information to the terminal, where the downlink information is carried on a downlink channel. The terminal sends an uplink signal or uplink information to the base station, where the uplink information is carried on an uplink channel. To communicate with the base station, the terminal needs to establish a wireless connection to a cell controlled by the base station. The cell that establishes the wireless connection to the terminal is referred to as a serving cell of the terminal. When communicating with the serving cell, the terminal is further interfered by a signal from a neighboring cell.

For ease of understanding embodiments of this application, the following first briefly describes terms in embodiments of this application. It should be understood that these descriptions are merely for ease of understanding embodiments of this application, and shall not constitute any limitation on this application.

### 1. Antenna Port

The antenna port is a logical concept. One antenna port corresponds to one or more antenna elements. Each antenna port may correspond to one reference signal (RS). Therefore, each antenna port may be referred to as a reference signal port.

### 2. Precoding Technology

The precoding technology means that a sending device (for example, an access network device) can process, when a channel state is known, a to-be-sent signal by using a precoding matrix that matches a channel condition, so that the to-be-sent signal that is pre-coded adapts to a channel. Therefore, a receiving device (for example, a terminal) can eliminate inter-channel interference by using corresponding equalization reception, and transmission performance is improved. Therefore, precoding processing is performed on the to-be-sent signal, to improve received signal quality. The signal quality herein may be a signal to interference plus noise ratio (SINR).

### 3. Precoding Matrix and Precoding Matrix Indicator (PMI)

The PMI may indicate the precoding matrix. For example, the precoding matrix may be obtained by performing singular value decomposition (SVD) on a channel matrix or a covariance matrix of a channel matrix. Alternatively, the precoding matrix may be obtained by performing eigenvalue decomposition (EVD) on the covariance matrix of the channel matrix. The channel matrix may be determined by a terminal through channel estimation and then reported to an access network device, or determined by an access network device based on channel reciprocity.

The PMI includes a single-polarized PMI and a dual-polarized PMI. The single-polarized PMI is a precoding matrix indicator in which quantization and a feedback is performed based on a channel feature in deployment of a single-polarized antenna array. A quantity of ports corresponding to a precoding matrix indicated by the single-polarized PMI is equal to a quantity of ports in the single-polarized antenna array. In embodiments of this application, a first PMI is used as an example to describe the single-polarized PMI. The dual-polarized PMI is a precoding matrix indicator in which quantization and a feedback is performed based on a channel feature in deployment of a dual-polarized antenna array. A quantity of ports corresponding to a precoding matrix indicated by the dual-polarized PMI is equal to a quantity of ports in the dual-polarized antenna array. Based on a current 5^{th} generation mobile communication technology new radio (5G NR) protocol, in the precoding matrix corresponding to the dual-polarized PMI, a precoding vector of each transmission stream generally includes two sub-vectors. The two sub-vectors respectively correspond to sub-vectors of the transport stream in two polarization directions. A precoding matrix formed by grouping sub-vectors of all transport streams in each polarization direction may be considered as a single-polarized PMI, and has a same dimension and a composition form as the precoding matrix corresponding to the foregoing single-polarized PMI. In embodiments of this application, a third PMI is used as an example to describe the dual-polarized PMI.

### 4. Channel State Information (CSI) and Channel State Information Report (CSI Report)

In a wireless communication system, the CSI is measured and calculated by a receiving device (such as a terminal). The CSI is a transmission parameter recommended by the receiving device to be used by a sending device, and indicates wireless channel information and interference information from the sending device (such as an access network device) to the receiving device. One piece of CSI may include at least one of a PMI, a rank indication (RI), a CQI, a channel state information reference signal (CSI-RS), and a resource indication.

A CSI report may include one piece of CSI, or may include a plurality of pieces of CSI. In other words, the receiving device may report one piece of CSI or a plurality of pieces of CSI to the sending device by using one CSI report. Different CSI may indicate wireless channel information and interference information on different frequency domain resources, or may indicate different solutions in which the sending device processes a signal. For example, different analog transmit beams may be indicated, or different coordinated scheduling modes between a plurality of sending devices may be indicated, or different antenna shutdown modes may be indicated. For example, one CSI report includes a plurality of pieces of CSI. Each piece of CSI includes a corresponding group of RIs, PMIs, or CQIs, respectively indicating a recommended quantity of transport streams, a recommended precoding vector, or recommended channel quality in an antenna shutdown pattern. Two different antenna shutdown patterns mean that index sets of two shutdown antenna ports in the two antenna shutdown patterns are different.

### 5. Codebook

The codebook is a set of precoding matrices. The codebook usually matches a dual-polarized antenna port. In embodiments of this application, dual-polarized directions are denoted as a polarization direction A and a polarization direction B. The following describes six types of codebooks.

For ease of understanding and description, the following describes main parameters involved in this application:
Ng: indicates a quantity of antenna panels.
N₁: indicates a quantity of antenna ports in a first dimension on an antenna panel, where the first dimension may be a horizontal dimension, and the horizontal dimension may be denoted as an H dimension.
N₂: indicates a quantity of antenna ports in a second dimension on an antenna panel, where the second dimension may be a vertical dimension, and the vertical dimension may be denoted as a V dimension.
O₁: indicates an oversampling factor of the first dimension on an antenna panel.
O₂: indicates an oversampling factor of the second dimension on an antenna panel.
R: indicates a quantity of transmission streams, where R is a positive integer. In embodiments of this application, a specific transport stream in the R transport streams may be described as the (r+1)^{th} transport stream, where 0≤r≤R−1.
Mᵣ: indicates a quantity of frequency domain base vectors of the (r+1)^{th} transport stream. In embodiments of this application, a specific base vector in the Mᵣ frequency domain base vectors may be described the (f+1)^{th} base vector, where 0≤f≤Mᵣ−1.
L: indicates a quantity of space domain base vectors. In embodiments of this application, a specific base vector in the L space domain base vectors may be described as the (l+1)^{th} base vector, where 0≤l≤L−1.
P_{CSI-RS}: indicates a quantity of CSI-RS antenna ports.

e represents a natural constant, j represents a unit imaginary number, π represents a circumference, and ┌ ┐ represents a rounding-up operator.

In a Type-1 single panel codebook, a codebook mode is used to determine a specific codebook. Specifically, the codebook mode can be used to determine whether a parameter is fed back by using a wideband or fed back by using a subband. In a Type-1 multi-panel codebook, a codebook mode indicates a selection manner of phase rotation factors between antenna panels. For example, in a codebook mode 1, phase rotation factors between two antenna panels are wideband factors. In other words, there are same phase rotation factors between two antenna panels on all subbands. In a codebook mode 2, phase rotation factors between two antenna panels are subband factors. In other words, there may be different phase rotation factors between two antenna panels on different subbands. The codebook mode 1 may be denoted as codebook mode=1. The codebook mode 2 may be denoted as codebook mode=2. In addition, codebook mode=1-2 indicates the codebook mode 1 and the codebook mode 2. It should be understood that, when codebook modes are different, manners in which parameters (for example, i₁ and i₂) in a PMI are mapped to codebook parameters (for example, l, m and n) may also be different.

It should be noted that, when there are a plurality of antenna panels, values of N₁ (or values of N₂, or values of O₁, or values of O₂) on different antenna panels may be the same, or may be different. Embodiments of this application is described by using an example in which the values of N₁ (or the values of N₂, or the values of O₁, or the values of O₂) on different antenna panels are the same.

(1) The Type-1 single panel codebook is described as follows:

When a quantity of ports is equal to 2, differentiation between a single-polarized antenna port and a dual-polarized antenna port is not required for the codebook.

When the quantity of ports is greater than or equal to 4 (for example, 4, 8, 12, 16, 24, or 32), the codebook is constructed by using i₁ and i₂. i₁ is used to determine precoding matrices W_{A}=[W_{A,1}, . . . , W_{A,R}] of all ports in a single-polarized direction (for example, the polarization direction A). W_{A} is a matrix formed by two-dimensional discrete Fourier transform (DFT) vectors. A value of i₁ satisfies the following formula:

$${i}_{1} = \{ \begin{matrix}[ \begin{matrix}{i}_{1 , 1} & {i}_{1 , 2} ]\end{matrix} & R ∉ \{ 2 , 3 , 4 \} \\ [ \begin{matrix}{i}_{1 , 1} & {i}_{1 , 2} & {i}_{1 , 3} ]\end{matrix} & R ∈ \{ 2 , 3 , 4 \}\end{matrix} \qquad Formula ( 1 - 1 )$$

i₂ is used to determine a precoding matrix W_{B}=[W_{B,1}, . . . , W_{B,R}] in another polarization direction (for example, a polarization direction B). Specifically, i₂ determines a phase rotation factor of a precoding vector w_{B,r} that is in the polarization direction B and that is relative to a precoding vector w_{A,r} of a same transport stream in the polarization direction A, to determine the precoding vector w_{B,r} and the precoding matrix W_{B} in the polarization direction B.

For example, a Type-1 single panel codebook is shown in Table 1-1.

TABLE 1-1
Codebook mode = 2, N₂ > 1

| i_{1,1} | i_{1,2} | i₂ | | | |
|---|---|---|---|---|---|
| | | 0 | 1 | 2 | 3 |
| $0 , 1 , … , \frac{{N}_{1} {O}_{1}}{2} - 1$ | $0 , 1 , … , \frac{{N}_{2} {O}_{2}}{2} - 1$ | W₂ᵢ_{_{1,1}}_{,2i}_{_{1,2}}_{,0}⁽¹⁾ | W₂ᵢ_{_{1,1}}_{,2i}_{_{1,2}}_{,1}⁽¹⁾ | W₂ᵢ_{_{1,1}}_{,2i}_{_{1,2}}_{,2}⁽¹⁾ | W₂ᵢ_{_{1,1}}_{,2i}_{_{1,2}}_{,3}⁽¹⁾ |
| i_{1,1} | i_{1,2} | i₂ | | | |
| | | 4 | 5 | 6 | 7 |
| $0 , 1 , … , \frac{{N}_{1} {O}_{1}}{2} - 1$ | $0 , 1 , … , \frac{{N}_{2} {O}_{2}}{2} - 1$ | W₂ᵢ_{_{1,1}}_{+1,2i}_{_{1,2}}_{,0}⁽¹⁾ | W₂ᵢ_{_{1,1}}_{+1,2i}_{_{1,2}}_{,1}⁽¹⁾ | W₂ᵢ_{_{1,1}}_{+1,2i}_{_{1,2}}_{,2}⁽¹⁾ | W₂ᵢ_{_{1,1}}_{+1,2i}_{_{1,2}}_{,3}⁽¹⁾ |
| i_{1,1} | i_{1,2} | i₂ | | | |
| | | 8 | 9 | 10 | 11 |
| $0 , 1 , … , \frac{{N}_{1} {O}_{1}}{2} - 1$ | $0 , 1 , … , \frac{{N}_{2} {O}_{2}}{2} - 1$ | W₂ᵢ_{_{1,1}}_{,2i}_{_{1,2}}_{+1,0}⁽¹⁾ | W₂ᵢ_{_{1,1}}_{,2i}_{_{1,2}}_{+1,1}⁽¹⁾ | W₂ᵢ_{_{1,1}}_{,2i}_{_{1,2}}_{+1,2}⁽¹⁾ | W₂ᵢ_{_{1,1}}_{,2i}_{_{1,2}}_{+1,3}⁽¹⁾ |
| i_{1,1} | i_{1,2} | i₂ | | | |
| | | 12 | 13 | 14 | 15 |
| $0 , 1 , … , \frac{{N}_{1} {O}_{1}}{2} - 1$ | $0 , 1 , … , \frac{{N}_{2} {O}_{2}}{2} - 1$ | W₂ᵢ_{_{1,1}}_{+1,2i}_{_{1,2}}_{,+10}⁽¹⁾ | W₂ᵢ_{_{1,1}}_{+1,2i}_{_{1,2}}_{,+11}⁽¹⁾ | W₂ᵢ_{_{1,1}}_{+1,2i}_{_{1,2}}_{,+12}⁽¹⁾ | W₂ᵢ_{_{1,1}}_{+1,2i}_{_{1,2}}_{,+13}⁽¹⁾ |
| ${W}_{l , m , n}^{( 1 )} = \frac{1}{\sqrt{{P}_{C S I - R S}}} [ \begin{matrix}{v}_{l , m} \\ {φ}_{n} {v}_{l , m}\end{matrix} ]$ | | | | | |

In Table 1-1, W_{l,m,n}⁽¹⁾ represents a precoding matrix, and a superscript (1) represents that a quantity of transport streams is R=1. A value of i_{1,1} is in a value range of

$$0 , 1 , … , \frac{{N}_{1} {O}_{1}}{2} - 1.$$

A value of i_{1,2} is in a value range of

$$0 , 1 , … , \frac{{N}_{2} {O}_{2}}{2} - 1.$$

A value of i₂ ranges from 0 to 15. In the codebook mode shown in Table 1-1, different values of i₂ indicate a change of the manner in which the parameters (for example, i_{1,1}, i_{1,2}, and i₂) are mapped to the codebook parameters (for example, l, m, and n). For example, when i₂=0, l=2i_{1,1}, m=2i_{1,2}, and n=0. For another example, when i₂=5, l=2i_{1,1}+1, m=2i_{1,2}, and n=1. In Table 1-1, the precoding matrix W_{l,m,n}⁽¹⁾ satisfies:

$${W}_{l , m , n}^{( 1 )} = \frac{1}{\sqrt{{P}_{C S I - R S}}} [ \begin{matrix}{v}_{l , m} \\ {φ}_{n} {v}_{l , m}\end{matrix} ] \qquad Formula ( 1 - 2 )$$

W_{l,m,n}⁽¹⁾ represents the precoding matrix. P_{CSI-RS} represents a quantity of CSI-RS ports, with a value of 2N₁×N₂. ν_{l,m} represents a two-dimensional DFT vector. φₙ represents a phase rotation factor between precoding matrices that control two polarization directions. ν_{l,m} and φₙ satisfy the following formula:

$$\{ \begin{matrix} \\ {φ}_{n} = {e}^{j π n / 2} \\ {u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix} \\ {v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m} \\ & & & \end{matrix} ]}^{T}\end{matrix} \qquad Formula ( 1 - 3 )$$

For another example, a Type-1 single panel codebook is shown in Table 1-2.

TABLE 1-2
Codebook mode = 1-2, P_{CSI-RS} ≥ 16

| i_{1,1} | i_{1,2} | i_{1,3} | i₂ | Wᵢ_{_{1,1}}_{,i}_{_{1,2}}_{,i}_{_{1,3}}_{,i}_{₂}⁽⁴⁾ |
|---|---|---|---|---|
| $0 , 1 , … , \frac{{N}_{1} {O}_{1}}{2} - 1$ | $0 , 1 , … , \frac{{N}_{2} {O}_{2}}{2} - 1$ | 0, 1, 2, 3 | 0, 1 | |

${W}_{l , m , p , n}^{( 4 )} = \frac{1}{\sqrt{4 {P}_{C S I - R S}}} [ \begin{matrix}{\tilde{v}}_{l , m} & {\tilde{v}}_{l , m} & {\tilde{v}}_{l , m} & {\tilde{v}}_{l , m} \\ {θ}_{p} {\tilde{v}}_{l , m} & - {θ}_{p} {\tilde{v}}_{l , m} & {θ}_{p} {\tilde{v}}_{l , m} & - {θ}_{p} {\tilde{v}}_{l , m} \\ {φ}_{n} {v}_{l , m} & {φ}_{n} {v}_{l , m} & - {φ}_{n} {v}_{l , m} & - {φ}_{n} {v}_{l , m} \\ {φ}_{n} {θ}_{p} {\tilde{v}}_{l , m} & - {φ}_{n} {θ}_{p} {\tilde{v}}_{l , m} & - {φ}_{n} {θ}_{p} {\tilde{v}}_{l , m} & {φ}_{n} {θ}_{p} {\tilde{v}}_{l , m}\end{matrix} ]$

In Table 1-2, W_{l,m,p,n}⁽⁴⁾ represents a precoding matrix, and a superscript (4) represents that a quantity of transport streams is R=4. For the value of i_{1,1} and the value of i_{1,2}, refer to descriptions in Table 1-1. Details are not described herein again. A value of i_{1,3} is one of 0, 1, 2, and 3, and a value of i₂ is 0 or 1. In the codebook mode shown in Table 1-2, l=i_{1,1}, m=i_{1,2}, p=i_{1,3}, and n=i₂. The precoding matrix W_{l,m,p,n}⁽⁴⁾ satisfies:

$${W}_{l , m , p , n}^{( 4 )} = \frac{1}{\sqrt{4 {P}_{C S I - R S}}} [ \begin{matrix}{\tilde{v}}_{l , m} & {\tilde{v}}_{l , m} & {\tilde{v}}_{l , m} & {\tilde{v}}_{l , m} \\ {θ}_{p} {\tilde{v}}_{l , m} & - {θ}_{p} {\tilde{v}}_{l , m} & {θ}_{p} {\tilde{v}}_{l , m} & - {θ}_{p} {\tilde{v}}_{l , m} \\ {φ}_{n} {v}_{l , m} & {φ}_{n} {v}_{l , m} & - {φ}_{n} {v}_{l , m} & - {φ}_{n} {v}_{l , m} \\ {φ}_{n} {θ}_{p} {\tilde{v}}_{l , m} & - {φ}_{n} {θ}_{p} {\tilde{v}}_{l , m} & - {φ}_{n} {θ}_{p} {\tilde{v}}_{l , m} & {φ}_{n} {θ}_{p} {\tilde{v}}_{l , m}\end{matrix} ] \qquad Formula ( 1 - 4 )$$

W_{l,m,p,n}⁽⁴⁾ represents the precoding matrix. P_{CSI-RS} represents a quantity of CSI-RS ports. A value of P_{CSI-RS} is 2N₁×N₂. \tilde{ν}_{l,m} represents a two-dimensional DFT vector. φₙ and θₚ represent phase rotation factors between precoding matrices that control two polarization directions. An expression of ν_{l,m} is the same as the formula (1-3). \tilde{ν}_{l,m}, φₙ, and θₚ satisfy the following formula:

$$\{ \begin{matrix}{φ}_{n} = {e}^{j π n / 2} \\ {θ}_{p} = {e}^{j π p / 4} \\ {u}_{m} = \{ \begin{matrix}[ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] & {N}_{2} > 1 \\ 1 & {N}_{2} = 1\end{matrix} \\ {\tilde{v}}_{l , m} = {[ \begin{matrix}{u}_{m} & {e}^{j \frac{4 π l}{{O}_{1} {N}_{1}}} {u}_{m} & … & {e}^{j \frac{4 π l ( {N}_{1} / 2 - 1 )}{{O}_{1} {N}_{1}}} {u}_{m} \\ & & & \end{matrix} ]}^{T}\end{matrix} \qquad Formula ( 1 - 5 )$$

In conclusion, in the Type-1 single panel codebook, the precoding matrix includes two parts that respectively correspond to two polarization directions. In other words, the Type-1 single panel codebook matches a port in a dual-polarized antenna array.

It should be noted that the foregoing two-dimensional DFT vector is a general term, and the “two-dimensional” may refer to the H dimension and the V dimension. When the H-dimensional parameter O₁N₁ is 1, a value of l is 0, and the foregoing two-dimensional DFT vector is degraded to a one-dimensional DFT vector. Alternatively, when the V-dimensional parameter O₂N₂ is 1, a value of m is 0. The foregoing two-dimensional DFT vector is degraded to a one-dimensional DFT vector.

(2) The Type-1 multi-panel codebook is described as follows:

In comparison with a quantity of antenna ports of the Type-1 single panel codebook, a quantity of antenna ports of the Type-1 multi-panel codebook is greater than or equal to 8, for example, 8, 16, or 32. N_{g}=2 or N_{g}=4. The Type-1 multi-panel codebook is constructed by using i₁ and i₂. A value of i₁ satisfies the following formula:

$${i}_{1} = \{ \begin{matrix}[ {i}_{1 , 1} {i}_{1 , 2} {i}_{1 , 4} ] & R = 1 \\ [ {i}_{1 , 1} {i}_{1 , 2} {i}_{1 , 3} {i}_{1 , 4} ] & R = 2\end{matrix} \qquad Formula ( 2 ‐ 1 )$$

i_{1,1}, i_{1,2}, and i_{1,3} are used to determine a two-dimensional DFT vector. For details, refer to descriptions of the Type-1 single panel codebook. Details are not described herein again. _{1,4} is used to determine phase rotation information between antenna panels in a plurality of antenna panels. i₂ is used to determine phase rotation information between different polarization directions.

In the codebook mode 1, i_{1,4} satisfies the following formula (2-2):

$${i}_{1 , 4} = \{ \begin{matrix} & {i}_{1 , 4 , 1} & & {N}_{g} = 2 \\ [ {i}_{1 , 4 , 1} & {i}_{1 , 4 , 2} & {i}_{1 , 4 , 3} ] & {N}_{g} = 4\end{matrix} \qquad Formula ( 2 ‐ 2 )$$

In the codebook mode 2, i_{1,4} and i₂ satisfy the following formula (2-3):

$$\{ \begin{matrix}{i}_{1 , 4} = [ {i}_{1 , 4 , 1} {i}_{1 , 4 , 2} ] & \\ {i}_{2} = \begin{matrix}[ {i}_{2 , 0} & {i}_{2 , 1} & {i}_{2 , 2} ]\end{matrix} & \end{matrix} \qquad Formula ( 2 ‐ 3 )$$

It should be understood that, in a related protocol, the formula (2-2) is applicable to a case in which N_{g}=2 or N_{g}=4. The formula (2-3) is applicable to the case in which N_{g}=2. The formula (2-3) is also applicable when N_{g}=4. This is not limited in embodiments of this application.

For example, a Type-1 multi-panel codebook is shown in Table 2-1.

TABLE 2-1
codebook mode = 1, N_{g} ∈ {2, 4}

| i_{1,1} | i_{1,2} | i_{1,4,q}, q = 1, . . . , N_{g}−1 | i₂ | Wᵢ_{_{1,1}}_{,i}_{_{1,1}}₊ₖ_{₁}_{,i}_{_{1,2}}₊ₖ_{₂}_{,i}_{_{1,4}}_{,i}_{₂}⁽²⁾ |
|---|---|---|---|---|
| 0, 1, · · · , N₁O₁ −1 | 0, 1, · · · , N₂O₂ −1 | 0, 1, 2, 3 | 0, 1 | |

${W}_{l , {l}^{′} , m , {m}^{′} , p , n}^{( 2 )} = \frac{1}{\sqrt{2}} [ \begin{matrix}{W}_{l , m , p , n}^{1 , {N}_{g} , 1} & {W}_{{l}^{′} , {m}^{′} , p , n}^{2 , {N}_{g} , 1}\end{matrix} ]$

For a mapping relationship between i_{1,3} and k₁ and a mapping relationship between i_{1,3} and k₂, refer to related descriptions in the 3GPP protocol TS 38.214. Details are not described herein. In Table 2-1, W_{l,l′,m,m′,p,n}⁽²⁾ represents a precoding matrix, and a superscript (2) represents that a quantity of transport streams is R=2. A value of i_{1,1} is in a value range of 0,1, . . . , N₁O₁−1. A value of i_{1,2} is in a value range of 0, . . . , N₂O₂−1. A value of i_{1,4,q} ranges from 0 to 3. A value of i₂ is 0 or 1. In the codebook mode shown in Table 2-1, l=i_{1,1}, l′=i_{1,1}+k₁, m=i_{1,2}, m′=i_{1,2}+k₂, p=i_{1,4}, and n=i₂. A precoding matrix W_{l,l′,m,m′,p,n}⁽²⁾ is shown in Table 2-1.

W_{l,l′,m,m′,p,n}⁽²⁾ represents the precoding matrix. p satisfies:

$$p = \{ \begin{matrix} & {p}_{1} & & {N}_{g} = 2 \\ [ {p}_{1} & {p}_{2} & {p}_{3} ] & {N}_{g} = 4\end{matrix} \qquad Formula ( 2 ‐ 4 )$$

When N_{g}=2, W_{l,m,p,n}^{1,N}^{_{g}}^{,1} and W_{l,m,p,n}^{2,N}^{_{g}}^{,1} satisfy:

$$\{ \begin{matrix}{W}_{l , m , p , n}^{1 , 2 , 1} = \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m}\end{matrix} ] \\ {W}_{l , m , p , n}^{2 , 2 , 1} = \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m}\end{matrix} ]\end{matrix} \qquad Formula ( 2 ‐ 5 )$$

When N_{g}=4, W_{l,m,p,n}^{1,N}^{_{g}}^{,1} and W_{l,m,p,n}^{2,N}^{_{g}}^{,1} satisfy:

$$\{ {W}_{l , m , p , n}^{1 , 4 , 1} = \text{} \frac{1}{\sqrt{{P}_{CSI - RS}}} [ \begin{matrix}{v}_{l , m} \\ {φ}_{n} {v}_{l , m} \\ {φ}_{{p}_{1}} {v}_{l , m} \\ {φ}_{n} {φ}_{{p}_{1}} {v}_{l , m} \\ {φ}_{{p}_{2}} {v}_{l , m} \\ {φ}_{n} {φ}_{{p}_{2}} {v}_{l , m} \\ {φ}_{{p}_{3}} {v}_{l , m} \\ {φ}_{n} {φ}_{{p}_{3}} {v}_{l , m}\end{matrix} ] {W}_{l , m , p , n}^{2 , 4 , 1} = \text{} \frac{1}{\sqrt{{P}_{CSI - RS}}} [ \begin{matrix}{v}_{l , m} \\ - {φ}_{n} {v}_{l , m} \\ {φ}_{{p}_{1}} {v}_{l , m} \\ - {φ}_{n} {φ}_{{p}_{1}} {v}_{l , m} \\ {φ}_{{p}_{2}} {v}_{l , m} \\ - {φ}_{n} {φ}_{{p}_{2}} {v}_{l , m} \\ {φ}_{{p}_{3}} {v}_{l , m} \\ - {φ}_{n} {φ}_{{p}_{3}} {v}_{l , m}\end{matrix} ] \qquad Formula ( 2 ‐ 6 )$$

In the formula (2-5) and the formula (2-6), for calculation of ν_{l,m} and φₙ, refer to the formula (1-3), and details are not described herein again. φₚ_{ᵢ} represents a phase rotation of the precoding matrix that is of the i+1^{th} antenna panel and that is relative to a precoding matrix of a first antenna panel. When N_{g}=2, φₚ_{ᵢ}=φₚ_{₁}. When N_{g}=4, φₚ_{ᵢ}=[φₚ_{₁} φₚ_{₂} φₚ_{₃}]. φₚ_{₁} represents a phase rotation of a precoding matrix that is of the second antenna panel and that is relative to the precoding matrix of the first antenna panel, and φₚ_{₁} is determined by using a parameter i_{1,4,1}. φₚ_{₂} represents a phase rotation of a precoding matrix that is of the third antenna panel and that is relative to the precoding matrix of the first antenna panel, and φₚ_{₂} is determined by using a parameter i_{1,4,2}. φₚ_{₃} represents a phase rotation of the precoding matrix of the fourth antenna panel relative to the precoding matrix of the first antenna panel, and φₚ_{₃} is determined by using a parameter i_{1,4,3}.

For another example, a Type-1 multi-panel codebook is shown in Table 2-2.

TABLE 2-2
Codebook mode = 2, N_{g} = 2

| i_{1,1} | i_{1,2} | i_{1,4,q,q=1,2} | i_{2,q,q=0,1,2} | Wᵢ_{_{1,1}}_{,i}_{_{1,1}}₊ₖ_{₁}_{,i}_{_{1,2}}₊ₖ_{₂}_{,i}_{_{1,4}}_{,i}_{₂}⁽²⁾ |
|---|---|---|---|---|
| 0, 1, · · · , N₁O₁ −1 | 0, 1, · · · , N₂O₂ −1 | 0, 1, 2, 3 | 0, 1 | |

${W}_{l , {l}^{′} , m , {m}^{′} , p , n}^{( 2 )} = \frac{1}{\sqrt{2}} [ \begin{matrix}{W}_{l , m , p , n}^{1 , {N}_{g} , 2} & {W}_{{l}^{′} , {m}^{′} , p , n}^{2 , {N}_{g} , 2}\end{matrix} ]$

For the value of i_{1,1}, the value of i_{1,2}, the value of i_{1,3}, and the value of i_{1,4,q}, refer to related descriptions in Table 2-1. Details are not described herein again. The value of i_{2,q} is 0 or 1. The precoding matrix is shown in Table 2-2.

p and n satisfy

$$\{ \begin{matrix}p = [ {p}_{1} {p}_{2} ] \\ n = [ {n}_{0} {n}_{1} {n}_{2} ]\end{matrix} \qquad Formula ( 2 ‐ 7 )$$

When N_{g}=2, W_{l,m,p,n}^{1,N}^{_{g}}^{,2} and W_{l′,m′,p,n}^{2,N}^{_{g}}^{,2} satisfy:

$$\{ \begin{matrix}{W}_{l , m , p , n}^{1 , 2 , 2} = \frac{1}{\sqrt{{P}_{CSI - RS}}} [ \begin{matrix}{v}_{l , m} \\ {φ}_{{n}_{0}} {v}_{l , m} \\ {a}_{{p}_{1}} {b}_{{n}_{1}} {v}_{l , m} \\ {a}_{{p}_{2}} {b}_{{n}_{2}} {v}_{l , m}\end{matrix} ] \\ {W}_{l , m , p , n}^{2 , 2 , 2} = \frac{1}{\sqrt{{P}_{CSI - RS}}} [ \begin{matrix}{v}_{l , m} \\ - {φ}_{{n}_{0}} {v}_{l , m} \\ {a}_{{p}_{1}} {b}_{{n}_{1}} {v}_{l , m} \\ - {a}_{{p}_{2}} {b}_{{n}_{2}} {v}_{l , m}\end{matrix} ]\end{matrix} \qquad Formula ( 2 ‐ 8 )$$

In the formula (2-8), for calculation of ν_{l,m} and φₙ_{₀}, refer to the formula (1-3), and details are not described herein again. aₚ and bₙ satisfy:

$$\{ \begin{matrix}{a}_{p} = {e}^{j π / 4} {e}^{j π p / 2} \\ {b}_{n} = {e}^{- j π / 4} {e}^{j π n / 2}\end{matrix} \qquad Formula ( 2 ‐ 9 )$$

φₙ_{₀} represents a rotation phase of a precoding matrix that is in the polarization direction B of the first antenna panel and that is relative to a precoding matrix in the polarization direction A of the first antenna panel, and is determined by using a parameter i_{2,0}. aₚ_{₁}bₙ_{₁} represents a rotation phase of a precoding matrix that is in the polarization direction A of the second antenna panel and that is relative to the precoding matrix in the polarization direction A of the first antenna panel, and is jointly determined by using parameters i_{1,4,1} and i_{2,1}. aₚ_{₂}bₙ_{₂} represents a rotation phase of a precoding matrix that is in the polarization direction B of the second antenna panel and that is relative to the precoding matrix in the polarization direction A of the first antenna panel, and is jointly determined by using the parameters i_{1,4,2} and i_{2,2}.

In conclusion, in the Type-1 multi-panel codebook, the precoding matrix includes two parts that respectively correspond to two polarization directions. In other words, the Type-1 multi-panel codebook matches a port in a dual-polarized antenna array.

(3) A Type-2 codebook is described as follows:

In a Type-1 codebook (for example, the Type-1 single panel codebook or the Type-1 multi-panel codebook), a precoding vector corresponding to each transport stream is a two-dimensional DFT vector. In the Type-2 codebook, a precoding vector corresponding to each transport stream is a linear weighted value of S two-dimensional DFT vectors. The linear weighted value includes an amplitude coefficient and a phase coefficient. The amplitude coefficient includes a wideband (WB) amplitude coefficient and a subband (SB) amplitude coefficient. The phase coefficient includes an SB phase coefficient. The quantity of transport streams is R=1 or R=2. The Type-2 codebook is constructed by using i₁ and i₂. A value of i₁ satisfies the following formula:

$${i}_{1} = \{ \begin{matrix}[ {i}_{1 , 1} {i}_{1 , 2} {i}_{1 , 3 , 1} {i}_{1 , 4 , 1} ] & R = 1 \\ [ {i}_{1 , 1} {i}_{1 , 2} {i}_{1 , 3 , 1} {i}_{1 , 4 , 1} {i}_{1 , 3 , 2} {i}_{1 , 4 , 2} ] & R = 2\end{matrix} \qquad Formula ( 3 ‐ 1 )$$

i_{1,1} and i_{1,2} are used to jointly determine S two-dimensional DFT vectors. A value of i_{1,1} satisfies:

$$\{ \begin{matrix}{i}_{1 , 1} = [ {q}_{1} {q}_{2} ] \\ {q}_{1} ∈ \{ 0 , 1 , … , {O}_{1} - 1 \} \\ {q}_{2} ∈ \{ 0 , 1 , … , {O}_{2} - 1 \}\end{matrix} \qquad Formula ( 3 ‐ 2 )$$

A value of i_{1,2} satisfies:

$${i}_{1 , 2} ∈ \{ 0 , 1 , … , ( \begin{matrix}{N}_{1} {N}_{2} \\ S\end{matrix} ) - 1 \} \qquad Formula ( 3 ‐ 3 )$$

For example, a process of determining the S two-dimensional DFT vectors is as follows: i_{1,2} is used to select the S two-dimensional DFT vectors from N₁N₂ two-dimensional DFT vectors. Oversampling factors of the N₁N₂ two-dimensional DFT vectors are set to 1. q₁ is used to determine an offset value when an oversampling factor is given in the horizontal dimension. q₂ is used to determine the offset value when an oversampling factor is given in the vertical dimension.

i_{1,3,r} represents an index of strongest two-dimensional DFT vectors of the (r+1)^{th} transport stream. A value range of i_{1,3,r} is [0,1, . . . , 2S−1]. In other words, i_{1,3,r} can indicate whether a strongest linear weighted value corresponds to the polarization direction A or the polarization direction B, and can indicate a base vector that corresponds to the strongest linear weighted value in the polarization direction.

i_{1,4,r}=[k_{r,0}⁽¹⁾, k_{r,1}⁽¹⁾, . . . , k_{r,2S-1}⁽¹⁾] represents wideband amplitude coefficients p_{i,l}⁽¹⁾ sub-precoding-vectors that are of the (r+1)^{th} transport stream in the polarization direction A and that are respectively on the S two-dimensional DFT vectors, and wideband amplitude coefficients p_{i,l+S}⁽¹⁾ of sub-precoding-vectors that are of the (r+1)^{th} transport stream in the polarization direction B and that are respectively on the S two-dimensional DFT vectors. For example, each wideband amplitude coefficient is quantized by using three bits.

A value of i₂ satisfies the following formula:

$${i}_{2} = \{ \begin{matrix}[ {i}_{2 , 1 , 1} ] & \\ [ {i}_{2 , 1 , 1} {i}_{2 , 1 , 2} ] & \\ [ {i}_{2 , 1 , 1} {i}_{2 , 2 , 1} ] & \\ \begin{matrix}[ {i}_{2 , 1 , 1} & {i}_{2 , 2 , 1} {i}_{2 , 1 , 2} {i}_{2 , 2 , 2} ]\end{matrix} & \end{matrix} \qquad Formula ( 3 ‐ 4 )$$

In the formula (3-4), the value of i₂ is related to a subband amplitude (subbandAmplitude) parameter and R. For example, when R=1 and “subbandAmplitude=false”, i₂=i_{2,1,1}. When R=2 and “subbandAmplitude=false”, i₂=[i_{2,1,1} i_{2,1,2}]. When R=1 and “subbandAmplitude=true”, i₂=[i_{2,1,1} i_{2,2,1}]. When R=2 and “subbandAmplitude=true”, i₂=[i_{2,1,1} i_{2,2,1} i_{2,1,2} i_{2,2,2}].

i_{2,1r}=[c_{r,0}, c_{r,1}, . . . , c_{r,2S-1}] represents subband phase coefficients φ_{i,l} of the sub-precoding-vectors that are of the (r+1)^{th} transport stream in the polarization direction A and that are respectively on the S two-dimensional DFT vectors, and subband phase coefficients φ_{i,l+S} of the sub-precoding-vectors that are of the (r+1)^{th} transport stream in the polarization direction B and that are respectively on the S two-dimensional DFT vectors. For example, quantization precision of each subband phase coefficient is selected from a phase shift-keying (PSK) constellation diagram (for example, an N-PSK constellation diagram), and is determined by using a parameter N_{PSK}, where N_{PSK}=4 or N_{PSK}=8.

i_{2,2,r}=[k_{r,0}⁽²⁾, k_{r,1}⁽²⁾, . . . , k_{r,2S-1}⁽²⁾] represents subband amplitude coefficients p_{i,l}⁽²⁾ of the sub-precoding-vectors that are of the (r+1)^{th} transport stream in the polarization direction A and that are respectively on the S two-dimensional DFT vectors, and subband amplitude coefficients Puits of the sub-precoding-vectors that are of the (r+1)^{th} transport stream in the polarization direction B and that are respectively on the S two-dimensional DFT vectors. For example, each subband amplitude coefficient is quantized by using one bit.

For example, the Type-2 codebook is shown in Table 3-1.

TABLE 3-1

| | |
|---|---|
| R = 1 | ${W}_{{q}_{1} , {q}_{2} , {n}_{1} , {n}_{2} , {p}_{1}^{( 1 )} , {p}_{1}^{( 2 )} , {i}_{2 , 1 , 1}}^{( 1 )} = {W}_{{q}_{1} , {q}_{2} , {n}_{1} , {n}_{2} , {p}_{1}^{( 1 )} , {p}_{1}^{( 2 )} , {i}_{2 , 1 , 1}}^{1}$ |
| R = 2 | ${W}_{{q}_{1} , {q}_{2} , {n}_{1} , {n}_{2} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ \begin{matrix}{W}_{{q}_{1} , {q}_{2} , {n}_{1} , {n}_{2} , {p}_{1}^{( 1 )} , {p}_{1}^{( 2 )} , {i}_{2 , 1 , 1}}^{1} & {W}_{{q}_{1} , {q}_{2} , {n}_{1} , {n}_{2} , {p}_{2}^{( 1 )} , {p}_{2}^{( 2 )} , {i}_{2 , 1 , 2}}^{2}\end{matrix} ]$ |

${W}_{{q}_{1} , {q}_{2} , {n}_{1} , {n}_{2} , {p}_{l}^{( 1 )} , {p}_{l}^{( 2 )} , {c}_{l}}^{l} = \frac{1}{\sqrt{{N}_{1} {N}_{2} {\sum }_{i = 0}^{2 S - 1} {( {p}_{l , i}^{( 1 )} {p}_{l , i}^{( 2 )} )}^{2}}} [ \begin{matrix}{\sum }_{i = 0}^{S - 1} {v}_{{m}_{1}^{( i )} , {m}_{2}^{( i )}} {p}_{i , l}^{( 1 )} {p}_{i , l}^{( 2 )} {φ}_{i , l} \\ {\sum }_{i = 0}^{S - 1} {v}_{{m}_{1}^{( i )} , {m}_{2}^{( i )}} {p}_{i , l + S}^{( 1 )} {p}_{i , l + S}^{( 2 )} {φ}_{i , l + S}\end{matrix} ]$
l = 1, 2

In Table 2-2, m₁⁽ⁱ⁾ represents an index of νₘ_{₁}⁽ⁱ⁾, m₂⁽ⁱ⁾ in the horizontal dimension when the oversampling factor is given. m₂⁽ⁱ⁾ represents an index of νₘ_{₁}⁽ⁱ⁾, m₂⁽ⁱ⁾ in the vertical dimension when the oversampling factor is given. For calculation of νₘ_{₁}⁽ⁱ⁾, m₂⁽ⁱ⁾, refer to the formula (1-3), and details are not described herein again.

In conclusion, in the Type-2 codebook, a precoding vector of each transport stream includes two parts that respectively correspond to sub-precoding-vectors in the two polarization directions. In other words, the Type-2 codebook matches a port in a dual-polarized antenna array.

(4) A Type-2 port selection codebook is described as follows:

In the Type-2 port selection codebook, a precoding vector corresponding to each transport stream is a linear weighted value of S unit vectors. For descriptions of a linear weighted value and a quantity of transport streams, refer to the descriptions of the Type-2 codebook. Details are not described herein again. The Type-2 port selection codebook is constructed by using i₁ and i₂. A value of i₁ satisfies the following formula:

$${i}_{1} = \{ \begin{matrix}[ {i}_{1 , 1} {i}_{1 , 3 , 1} {i}_{1 , 4 , 1} ] & R = 1 \\ [ {i}_{1 , 1} {i}_{1 , 3 , 1} {i}_{1 , 4 , 1} {i}_{1 , 3 , 2} {i}_{1 , 4 , 2} ] & R = 2\end{matrix} \qquad Formula ( 4 ‐ 1 )$$

i_{1,1} determines S unit vectors. A value of i_{1,1} satisfies the formula (3-2).

For example, a process of determining S unit vectors is as follows: First, a port selection sampling size (portSelectionSamplingSize) parameter d is determined, where d does not satisfy d≤min {P_{CSI-RS}/2, S}. Then S unit vectors are determined based on the value of i_{1,1}. i_{1,1}∈{0,1, . . . , ┌P_{CSI-RS}2d┐}. One of the S unit vectors may be denoted as νᵢ_{_{1,1}}_{d+l}, where l=0,1, . . . , S−1. νᵢ_{_{1,1}}_{d+l} is a vector with a length of P_{CSI-RS}/2. In νᵢ_{_{1,1}}_{d+l}, a value of the (i_{1,1}d+l+1)^{th} element is 1, and values of other elements are 0.

i_{1,3,r} represents an index of strongest unit vectors of the (r+1)^{th} transport stream. A value range of i_{1,3,r} is [0,1, . . . , 2S−1]. In other words, i_{1,3,r} indicates whether a strongest linear weighted value corresponds to the polarization direction A or the polarization direction B, and indicates a base vector number that corresponds to the strongest linear weighted value in the polarization direction.

i_{1,4,r}=[k_{r,0}⁽¹⁾, k_{r,1}⁽¹⁾, . . . , k_{r,2S-1}⁽¹⁾] represents wideband amplitude coefficients p_{i,l}⁽¹⁾ or (r+1)^{th} sub-precoding-vectors that are with a transport stream in the polarization direction A and that are on the S unit vectors, and wideband amplitude coefficients p_{i,l+S}⁽¹⁾ of (r+1)^{th} sub-precoding-vectors that are with a transport stream in the polarization direction B and that are on the S unit vectors. For example, each wideband amplitude coefficient is quantized by using three bits.

For a value of i₂, refer to the descriptions of the Type-2 codebook. Details are not described herein again.

i_{2,1,r}=[c_{r,0}, c_{r,1}, . . . , c_{r,2S-1}] represents subband phase coefficients φ_{i,l} of the (r+1)^{th} sub-precoding-vectors that are with the transport stream in the polarization direction A and that are on the S unit vectors, and subband phase coefficients φ_{i,l+S} of the (r+1)^{th} sub-precoding-vectors that are with the transport stream in the polarization direction B and that on the S unit vectors. For example, quantization precision of each subband phase coefficient is selected from a PSK constellation diagram (for example, an N-PSK constellation diagram), and is determined by using the parameter N_{PSK}, where N_{PSK}=4, or N_{PSK}=8.

i_{2,2,r}=[k_{r,0}⁽²⁾, k_{r,1}⁽²⁾, . . . , k_{r,2S-1}⁽²⁾] represents subband phase coefficients p_{i,l}⁽²⁾ of the (r+1)^{th} sub-precoding-vectors that are with the transport stream in the polarization direction A and that are on the S unit vectors, and subband phase coefficients p_{i,l+S}⁽²⁾ of the (r+1)^{th} sub-precoding-vectors that are with the transport stream in the polarization direction B and that on the S unit vectors. For example, each subband amplitude coefficient is quantized by using one bit.

For example, the Type-2 port selection codebook is shown in Table 4-1.

TABLE 4-1

| | |
|---|---|
| R = 1 | ${W}_{{i}_{1 , 1} , {p}_{1}^{( 1 )} , {p}_{1}^{( 2 )} , {i}_{2 , 1 , 1}}^{( 1 )} = {W}_{{i}_{1 , 1} , {p}_{1}^{( 1 )} , {p}_{1}^{( 2 )} , {i}_{2 , 1 , 1}}^{1}$ |
| R = 2 | ${W}_{{i}_{1 , 1} , {p}_{1}^{( 1 )} , {p}_{1}^{( 2 )} , {i}_{2 , 1 , 1} , {p}_{2}^{( 1 )} , {p}_{2}^{( 2 )} , {i}_{2 , 1 , 2}}^{( 2 )} = \frac{1}{\sqrt{2}} [ \begin{matrix}{W}_{{i}_{1 , 1} , {p}_{1}^{( 1 )} , {p}_{1}^{( 2 )} , {i}_{2 , 1 , 1}}^{1} & {W}_{{i}_{i , i} , {p}_{2}^{( 1 )} , {p}_{2}^{( 2 )} , {i}_{2 , 1 , 2}}^{2}\end{matrix} ]$ |

${W}_{{i}_{1 , 1} , {p}_{l}^{( 1 )} , {p}_{l}^{( 2 )} , {i}_{2 , 1 , l}}^{l} = \frac{1}{\sqrt{{\sum }_{i = 0}^{2 S - 1} {( {p}_{l , i}^{( 1 )} {p}_{l , i}^{( 2 )} )}^{2}}} [ \begin{matrix}{\sum }_{i = 0}^{S - 1} {v}_{{i}_{1 , 1} d + l} {p}_{i , l}^{( 1 )} {p}_{i , l}^{( 2 )} {φ}_{i , l} \\ {\sum }_{i = 0}^{S - 1} {v}_{{i}_{1 , 1} d + l} {p}_{i , l + S}^{( 1 )} {p}_{i , l + S}^{( 2 )} {φ}_{i , l + S}\end{matrix} ]$
l = 1 ,2.

In conclusion, in the Type-2 port selection codebook, a precoding vector of each transport stream includes two parts that respectively correspond to sub-precoding-vectors in the two polarization directions. In other words, the Type-2 port selection codebook matches a port in a dual-polarized antenna array.

(5) The enhanced Type-2 codebook (enhanced Type-II codebook) is described as follows:

In the Type-2 codebook, a subband PMI feedback is supported. In this case, a linear weighted value of each subband includes a subband amplitude coefficient and a subband phase coefficient, and a parameter feedback amount is large. In the enhanced Type-2 codebook, a space-frequency two-dimensional joint feedback is performed. It is assumed that a quantity of subbands for which PMIs are to feed back in the enhanced Type-2 codebook is N₃. The enhanced Type-2 codebook includes a precoding matrix 2N₁N₂×N₃×R. On each transport stream, a space-frequency two-dimensional precoding matrix W of 2N₁ N₂×N₃ dimensions may be represented as a matrix formed by three matrices: a matrix W₁ that is of 2N₁N₂×2L dimensions and that is formed by a space domain (SD) base vector, a matrix W_{f} that is of N₃×M dimensions and that is formed by a frequency domain (FD) base vector, and a coefficient matrix \tilde{W}₂ that is formed by performing linear combination on column vectors. The SD base vector is a two-dimensional DFT vector. The FD base vector is a one-dimensional DFT vector at a size of N₃.

A maximum quantity of transport streams supported by the enhanced Type-2 codebook is R=4. Each space-frequency two-dimensional precoding matrix W is constructed by using i₁ and i₂. A value of i₁ satisfies the following formula:

$${i}_{1} = \text{} \{ \begin{matrix}[ {i}_{1 , 1} {i}_{1 , 2} {i}_{1 , 5} {i}_{1 , 6 , 1} {i}_{1 , 7 , 1} {i}_{1 , 8 , 1} ] & R = 1 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} ] & R = 2 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} ] & R = 3 \\ [ {i}_{1 , 1} {i}_{1 , 2} {i}_{1 , 5} {i}_{1 , 6 , 1} {i}_{1 , 7 , 1} {i}_{1 , 8 , 1} {i}_{1 , 6 , 2} {i}_{1 , 7 , 2} {i}_{1 , 8 , 2} {i}_{1 , 6 , 3} {i}_{1 , 7 , 3} {i}_{1 , 8 , 3} {i}_{1 , 6 , 4} {i}_{1 , 7 , 4} {i}_{1 , 8 , 4} ] & R = 4\end{matrix} \qquad Formula ( 5 ‐ 1 )$$

A value of i₂ satisfies the following formula:

$${i}_{2} = \{ \begin{matrix}[ \begin{matrix}{i}_{2 , 3 , 1} & {i}_{2 , 4 , 1} & {i}_{2 , 5 , 1} ]\end{matrix} & R = 1 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} ]\end{matrix} & R = 2 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3} ]\end{matrix} & R = 3 \\ [ \begin{matrix}{i}_{2 , 3 , 1} & {i}_{2 , 4 , 1} & {i}_{2 , 5 , 1} & {i}_{2 , 3 , 2} & {i}_{2 , 4 , 2} & {i}_{2 , 5 , 2} & {i}_{2 , 3 , 3} & {i}_{2 , 4 , 3} & {i}_{2 , 5 , 3} & {i}_{2 , 3 , 4} & {i}_{2 , 4 , 4} & {i}_{2 , 5 , 4} ]\end{matrix} & R = 4\end{matrix} \qquad ( Formula 5 - 2 )$$

In a process of determining the enhanced Type-2 codebook, the following items need to be determined:

A first item is the quantity of subbands N₃.

A second item is a quantity S of SD base vectors. The quantity S of SD base vectors is determined based on a parameter ParaCombination-r16. S SD base vectors are jointly determined based on i_{1,1} and i_{1,2}. For details, refer to the descriptions of the Type-2 codebook. Details are not described herein again.

A third item is a quantity Mᵣ of FD base vectors of the r^{th} transport stream, where

$${M}_{r} = ⌈ {p}_{r} \frac{{N}_{3}}{R} ⌉ .$$

K₀ is a maximum quantity of non-zero (NZ) linear combination (LC) coefficients, and satisfies K₀≤┌β*2SM₁┐. M₁ represents a quantity of FD base vectors of the 1^{st} transport stream. For values of β and S, refer to Table 5-1.

TABLE 5-1

| | | pᵣ | | |
|---|---|---|---|---|
| ParaCombination-r16 | S | R ∈ {1, 2} | R ∈ {3, 4} | β |
| 1 | 2 | 1/4 | 1/8 | 1/4 |
| 2 | 2 | 1/4 | 1/8 | 1/2 |
| 3 | 4 | 1/4 | 1/8 | 1/4 |
| 4 | 4 | 1/4 | 1/8 | 1/2 |
| 5 | 4 | 1/4 | 1/4 | 3/4 |
| 6 | 4 | 1/4 | 1/4 | 1/2 |
| 7 | 6 | 1/4 | / | 1/2 |
| 8 | 6 | 1/4 | / | 3/4 |

In Table 5-1, when a value of ParaCombination-r16 is 1, the value of S is 2, and the value of β is ¼. When R∈{1,2}, the value of pᵣ is ¼. When R∈{3,4}, the value of pᵣ is ⅛. For another case, refer to Table 5-1. Details are not described herein again.

An index of one FD base vector is denoted as 0. Indexes of two or more FD base vectors are respectively denoted as 0 and n_{3,i}. n_{3,r}=[n_{3,r}⁽⁰⁾, . . . , n_{3,r}^{(M}^{ᵣ}⁻¹⁾], and is determined by using parameters i_{1,6,r} and i_{1,5}. For details, refer to a conventional technology. Details are not described herein.

A fourth item is an NZ LC coefficient. The following describes the NZ LC coefficient in three aspects:

A first aspect is related to a position of the NZ LC coefficient. The position of the NZ LC coefficient is determined by a parameter i_{1,7,r}, where i_{1,7,r} satisfies:

$$\{ \begin{matrix}{i}_{1 , 7 , r} = [ {k}_{r , 0}^{( 3 )} … {k}_{r , {M}_{r} - 1}^{( 3 )} ] \\ {k}_{r , f}^{( 3 )} = [ {k}_{r , 0 , f}^{( 3 )} … {k}_{r , 2 S - 1 , f}^{( 3 )} ] \\ {k}_{r , l , f}^{( 3 )} ∈ \{ 0 , 1 \} \\ f = [ 0 , 1 , … , {M}_{r} - 1 ]\end{matrix} \qquad Formula ( 5 - 3 )$$

k_{r,l,f}⁽³⁾ indicates whether an LC coefficient corresponding to the (f+1)^{th} FD base vector and the (l+1)^{th} SD base vector in the (r+1)^{th} transport stream is NZ or 0. If k_{r,l,f}⁽³⁾=0, a value of the LC coefficient at the position is 0, and a feedback is not needed. If k_{r,l,f}⁽³⁾=1, a value of the LC coefficient at the position is non-zero, and a feedback is needed.

A second aspect is related to a position of a strongest NZ LC coefficient of each transport stream. The position of the strongest NZ LC coefficient of each transport stream is denoted as (lᵣ*, fᵣ*), where fᵣ*=0 , and lᵣ* is determined by using a parameter i_{1,8,r}.

A third aspect is related to amplitude information and phase information of the NZ LC coefficient.

For the R transport streams, the terminal reports an NZ LC coefficient of each transport stream to a network device. The NZ LC coefficient of each transport stream includes a common coefficient, an LC amplitude coefficient, and an LC phase coefficient.

The common coefficient is denoted as [p_{r,0}⁽¹⁾, p_{r,1}⁽¹⁾], and is determined by using a parameter i_{2,3,r}, where i_{2,3,r}=[k_{r,0}⁽¹⁾ k_{r,1}⁽¹⁾].

The LC amplitude coefficient is denoted as p_{r,l,f}⁽²⁾, where f=0,1, . . . , Mᵣ−1. p_{r,l,f}⁽²⁾ is determined by using a parameter i_{2,4,r}. The parameter i_{2,4,r} satisfies:

$$\{ \begin{matrix}{i}_{2 , 4 , r} = [ {k}_{r , 0}^{( 2 )} … {k}_{r , {M}_{r} - 1}^{( 2 )} ] \\ {k}_{r , f}^{( 2 )} = [ {k}_{r , 0 , f}^{( 2 )} … {k}_{r , 2 S - 1 , f}^{( 2 )} ]\end{matrix} \qquad Formula ( 5 - 4 )$$

The LC phase coefficient is denoted as φ_{i,l,f}, where f=0,1, . . . , Mᵣ−1. p_{r,l,f}⁽²⁾ is determined by using a parameter i_(2,5,r). The parameter i_{2,5,r} satisfies the following requirements:

$$\{ \begin{matrix}{i}_{2 , 5 , r} = [ {c}_{r , 0} … {c}_{r , {M}_{r} - 1} ] \\ {c}_{r , f} = [ {c}_{r , 0 , f} … {c}_{r , 2 S - 1 , f} ]\end{matrix} \qquad Formula ( 5 - 5 )$$

For example, the enhanced Type-2 codebook is shown in Table 5-2.

TABLE 5-2

| | |
|---|---|
| R = 1 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{( 1 )} \qquad = {W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1}$ |
| R = 2 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} ]\end{matrix}$ |
| R = 3 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \\ \frac{1}{\sqrt{3}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} & {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5 , 3} , t}^{3}\end{matrix} ]$ |
| R = 4 | ${W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \\ \frac{1}{\sqrt{2}} [ \begin{matrix}{W}_{{q}_{1} , {q}_{2} , {n}_{1} , {n}_{2} , {n}_{3 , 1} , {p}_{1}^{( 1 )} , {p}_{1}^{( 2 )} , {i}_{2 , 5 , 1} , t}^{1} & {W}_{{q}_{1} , {q}_{2} , {n}_{1} , {n}_{2} , {n}_{3 , 2} , {p}_{2}^{( 1 )} , {p}_{2}^{( 2 )} , {i}_{2 , 5 , 2} , t}^{2} & {W}_{{q}_{1} , {q}_{2} , {n}_{1} , {n}_{2} , {n}_{3 , 3} , {p}_{3}^{( 1 )} , {p}_{3}^{( 2 )} , {i}_{2 , 5 , 3} , t}^{3} & {W}_{{q}_{1} , {q}_{2} , {n}_{1} , {n}_{2} , {n}_{3 , 4} , {p}_{4}^{( 1 )} , {p}_{4}^{( 2 )} , {i}_{2 , 5 , 4} , t}^{4}\end{matrix} ]$ |

${W}_{{q}_{1} , {q}_{2} , {n}_{1} , {n}_{2} , {n}_{3} , {p}_{1}^{( 1 )} , {p}_{1}^{( 2 )} , {i}_{2 , 5 , l} , t}^{l} = \frac{1}{\sqrt{{N}_{1} {N}_{2} {γ}_{t , l}}} [ \begin{matrix}{\sum }_{i = 0}^{S - 1} {v}_{{m}_{1}^{( i )} , {m}_{2}^{( i )}} {p}_{l , 0}^{( 1 )} {\sum }_{f = 0}^{{M}_{r} - 1} {y}_{t , l}^{( f )} {p}_{i , l , f}^{( 2 )} {φ}_{i , l , f} \\ {\sum }_{i = 0}^{S - 1} {v}_{{m}_{1}^{( i )} , {m}_{2}^{( i )}} {p}_{l , 1}^{( 1 )} {\sum }_{f = 0}^{{M}_{r} - 1} {y}_{t , l}^{( f )} {p}_{i , l + S , f}^{( 2 )} {φ}_{i , l + S , f}\end{matrix} ]$
${γ}_{t , l} = {\sum }_{i = 0}^{2 S - 1} {( {p}_{l , \vert \frac{i}{S} \vert}^{( 1 )} )}^{2} {\vert {\sum }_{f = 0}^{{M}_{r} - 1} {y}_{t , l}^{( f )} {p}_{i , l , f}^{( 2 )} {φ}_{i , l , f} \vert}^{2}$
${y}_{t , i}^{( f )} = {e}^{j \frac{2 π {tn}_{3 , i}^{( f )}}{{N}_{3}}} , t = 0 , 1 … {N}_{3} - 1$
l = 1, 2, 3, 4

In conclusion, in the enhanced Type-2 codebook, a precoding vector of each transport stream includes two parts that respectively correspond to sub-precoding-vectors in the two polarization directions. In other words, the enhanced Type-2 codebook matches a port in a dual-polarized antenna array.

(6) Enhanced Type-2 port selection codebook (enhanced Type-II port selection codebook) is described as follows:

In comparison with the S SD base vectors in the enhanced Type-2 codebook, S SD basis vectors in the enhanced port selection Type-2 codebook are unit vectors. The S SD base vectors are determined based on i_{1,1}. For details, refer to the descriptions of the Type-2 port selection codebook. Details are not described herein again.

A maximum quantity of transport streams supported by the enhanced Type-2 port selection codebook is R=4. Each space-frequency two-dimensional precoding matrix W is constructed by using i₁ and i₂. A value of i₁ satisfies the following formula:

$${i}_{1} = \{ \begin{matrix}[ \begin{matrix}{i}_{1 , 1} & {i}_{1 , 5} & {i}_{1 , 6 , 1} & {i}_{1 , 7 , 1} & {i}_{1 , 8 , 1} ]\end{matrix} & R = 1 \\ [ \begin{matrix}{i}_{1 , 1} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} ]\end{matrix} & R = 2 \\ [ \begin{matrix}{i}_{1 , 1} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 2} & {i}_{1 , 7 , 3} & {i}_{1 , 8 , 3} ]\end{matrix} & R = 3 \\ [ \begin{matrix}{i}_{1 , 1} & {i}_{1 , 5} & {i}_{1 , 6 , 1} & {i}_{1 , 7 , 1} & {i}_{1 , 8 , 1} & {i}_{1 , 6 , 2} & {i}_{1 , 7 , 2} & {i}_{1 , 8 , 2} & {i}_{1 , 6 , 2} & {i}_{1 , 7 , 3} & {i}_{1 , 8 , 3} & {i}_{1 , 6 , 4} & {i}_{1 , 7 , 4} & {i}_{1 , 8 , 4} ]\end{matrix} & R = 4\end{matrix} \qquad Formula ( 6 - 1 )$$

A value of i₂ satisfies the formula (5-2), and details are not described herein again.

For a process of determining the enhanced Type-2 port selection codebook, refer to the descriptions of the enhanced Type-2 codebook. Details are not described herein again.

For example, the enhanced Type-2 port selection codebook is shown in Table 6-1.

TABLE 6-1

| | |
|---|---|
| R = 1 | ${W}_{{i}_{1 , 1} , {n}_{3 , 1} , {p}_{1}^{( 1 )} , {p}_{1}^{( 2 )} , {i}_{2 , 5 , 1} , t}^{( 1 )} = {W}_{{i}_{1 , 1} , {n}_{3 , 1} , {p}_{1}^{( 1 )} , {p}_{1}^{( 2 )} , {i}_{2 , 5 , 1} , t}^{1}$ |
| R = 2 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , t}^{( 2 )} = \frac{1}{\sqrt{2}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{i , i} , {n}_{3 , 2} , {p}_{1}^{( 1 )} , {p}_{2}^{( 2 )} , {i}_{2 , 5 , 2} , t}^{2}\end{matrix} ]$ |
| R = 3 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , t}^{( 3 )} = \\ \frac{1}{\sqrt{3}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{i , i} , {n}_{3 , 2} , {p}_{2}^{( 1 )} , {p}_{2}^{( 2 )} , {i}_{2 , 5 , 2} , t}^{2} & {W}_{{i}_{i , i} , {n}_{3 , 3} , {p}_{3}^{( 1 )} , {p}_{3}^{( 2 )} , {i}_{2 , 5 , 3} , t}^{3}\end{matrix} ]$ |
| R = 4 | ${W}_{{i}_{1 , 1} , {n}_{3 , 1} , {p}_{1}^{( 1 )} , {p}_{1}^{( 2 )} , {i}_{2 , 5 , 1} , {n}_{3 , 2} , {p}_{2}^{( 1 )} , {p}_{2}^{( 2 )} , {i}_{2 , 5 , 2} , {n}_{3 , 3} , {p}_{3}^{( 1 )} , {p}_{3}^{( 2 )} , {i}_{2 , 5 , 3} , {n}_{3 , 4} , {p}_{4}^{( 1 )} , {p}_{4}^{( 2 )} , {i}_{2 , 5 , 4} , t}^{( 4 )} = \\ \frac{1}{\sqrt{2}} [ \begin{matrix}{W}_{{i}_{1 , 1} , {n}_{3 , 1} , {p}_{1}^{( 1 )} , {p}_{1}^{( 2 )} , {i}_{2 , 5 , 1} , t}^{1} & {W}_{{i}_{1 , 1} , {n}_{3 , 2} , {p}_{2}^{( 1 )} , {p}_{2}^{( 2 )} , {i}_{2 , 5 , 2} , t}^{2} & {W}_{{i}_{1 , 1} , {n}_{3 , 3} , {p}_{3}^{( 1 )} , {p}_{3}^{( 2 )} , {i}_{2 , 5 , 3} , t}^{3} & {W}_{{i}_{1 , 1} , {n}_{3 , 4} , {p}_{4}^{( 1 )} , {p}_{4}^{( 2 )} , {i}_{2 , 5 , 4} , t}^{4}\end{matrix} ]$ |

${W}_{{i}_{1 , 1} , {n}_{3} , {p}_{l}^{( 1 )} , {p}_{l}^{( 2 )} , {i}_{2 , 5 , l} , t}^{l} = \frac{1}{\sqrt{{γ}_{t , l}}} [ \begin{matrix}{\sum }_{i = 0}^{S - 1} {v}_{{i}_{1 , 1} d + l} {p}_{l , 0}^{( 1 )} {\sum }_{f = 0}^{{M}_{r} - 1} {y}_{t , l}^{( f )} {p}_{i , l , f}^{( 2 )} {φ}_{i , l , f} \\ {\sum }_{i = 0}^{S - 1} {v}_{{i}_{1 , 1} d + l} {p}_{l , 1}^{( 1 )} {\sum }_{f = 0}^{{M}_{r} - 1} {y}_{t , l}^{( f )} {p}_{i , l + S , f}^{( 2 )} {φ}_{i , l + S , f}\end{matrix} ]$
${γ}_{t , l} = {\sum }_{i = 0}^{2 S - 1} {( {p}_{l , \vert \frac{i}{S} \vert}^{( 1 )} )}^{2} {\vert {\sum }_{f = 0}^{{M}_{r} - 1} {y}_{t , l}^{( f )} {p}_{i , l , f}^{( 2 )} {φ}_{i , l , f} \vert}^{2}$
${y}_{t , i}^{( f )} = {e}^{j \frac{2 π {tn}_{3 , i}^{( f )}}{{N}_{3}}} , t = 0 , 1 … {N}_{3} - 1$
l = 1, 2, 3, 4

In conclusion, in the enhanced Type-2 port selection codebook, a precoding vector of each transport stream includes two parts that respectively correspond to sub-precoding-vectors in the two polarization directions. In other words, the enhanced Type-2 port selection codebook matches a port in a dual-polarized antenna array.

However, all existing codebooks are designed for the dual-polarized antenna array. When the antenna array is a single-polarized antenna array, use of the codebook and a feedback manner in the dual-polarized antenna array is not appropriate. For example, when an antenna array is deployed in a dual-polarized manner, a channel gain in the second polarization direction usually has a fixed offset value in comparison with a channel gain in the first polarization direction. Therefore, during construction of the dual-polarized codebook, it is generally assumed that a precoding vector in the precoding matrix is represented by using one sub-vector and one offset value. A quantity of ports in one polarization direction is a half of a quantity of ports in an entire antenna array. The one sub-vector herein corresponds to a precoding vector on a port in the first polarization direction, and a product of the offset value and the foregoing one sub-vector corresponds to a precoding vector on a port in the second polarization direction. Apparently, when the antenna array is deployed in a single-polarized manner, there are no fixed offset values between the channel gain on a half of ports and the channel gain on the other half of ports. In this case, if a precoding vector in a fed-back precoding matrix is still indicated by using the one sub-vector and the one offset value, the fed-back precoding matrix no longer matches a channel feature. Consequently, a feedback error or a decrease in feedback accuracy exists.

In view of this, embodiments of this application provide a precoding matrix indicator feedback method applied to the communication system shown in FIG. 1. In the precoding matrix indicator feedback method according to an embodiment of this application, a terminal first determines a first PMI, and then sends the first PMI to an access network device. The first PMI indicates a precoding matrix W. The precoding matrix W includes R precoding vectors wᵢ, where i=0,1,2, . . . , R−1. The precoding vector wᵢ is a column vector with a length of N₁×N₂×N_{g}. N_{g} represents a quantity of antenna panels. N₁ represents a quantity of ports in a first dimension on one antenna panel. N₂ represents a quantity of ports in a second dimension on the antenna panel. N₁, N₂, and N_{g} are all positive integers, and at least one of N₁, N₂, and N_{g} is greater than or equal to 2. The precoding vector wᵢ represents a precoding vector in a polarization direction. In this case, the first PMI fed back by the terminal matches a single-polarized antenna array, and belongs to a single-polarized parameter.

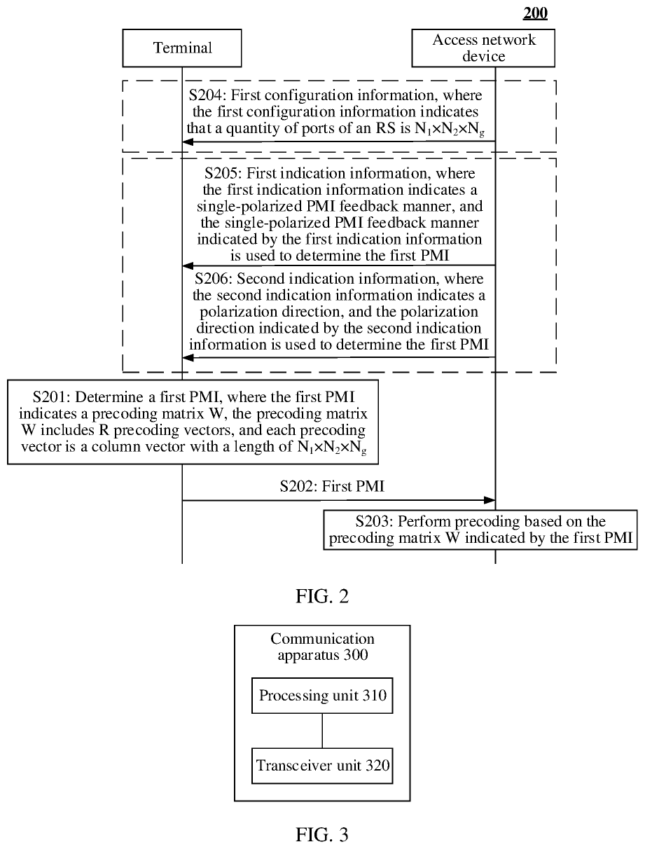

With reference to FIG. 2, the following describes in detail the precoding matrix indicator feedback method 200 according to an embodiment of this application.

S201: A terminal determines a first PMI.

The first PMI indicates a precoding matrix W. The precoding matrix W includes R precoding vectors wᵢ, and i=0,1,2, . . . , R−1. For example, W=[w₀, . . . , w_{R-1}]. The precoding vector wᵢ is a column vector with a length of N₁×N₂×N_{g}. N₁, N₂, and N_{g} are all positive integers, and at least one of N₁, N₂, and N_{g} greater than or equal to 2. N₁ represents a quantity of antenna ports in a first dimension on an antenna panel. N₂ represents a quantity of antenna ports in a second dimension on the antenna panel. The first dimension may be a horizontal dimension, or may be a vertical dimension. Correspondingly, when the first dimension is the horizontal dimension, the second dimension is the vertical dimension. When the first dimension is the vertical dimension, the second dimension is the horizontal dimension. In embodiments of this application, an example in which the first dimension is the horizontal dimension and the second dimension is the vertical dimension is used for description.

The following provides detailed designs for six types of codebooks.

### (1) Type-1 Single Panel Codebook

In the Type-1 single panel codebook, two key points are described.

Key point 1: When a quantity of ports is greater than or equal to 4, the precoding matrix W reserves a precoding vector in a polarization direction. For example, the precoding vector wᵢ is a two-dimensional DFT vector. The two-dimensional DFT vector satisfies:

$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , ... , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , ... , {e}^{j \frac{2 π {m}_{i} ( {N}_{2} - 1 )}{{O}_{2} {N}_{2}}} ]\end{matrix} \qquad Formula ( 7 - 1 )$$

νₗ_{ᵢ}_{,m}_{ᵢ} represents the two-dimensional DFT vector. (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1.

Key point 2: The first PMI is used to determine (lᵢ, mᵢ).

For example, the first PMI includes a parameter i₁, and does not include a parameter i₂. The parameter i₁ satisfies:

$${i}_{1} = \{ \begin{matrix}[ \begin{matrix}{i}_{1 , 1} & {i}_{1 , 2} ]\end{matrix} & R = 1 \\ [ \begin{matrix}{i}_{1 , 1} & {i}_{1 , 2} & {i}_{1 , 3} ]\end{matrix} & R \geq 2\end{matrix} \qquad Formula ( 7 - 2 )$$

For a process of determining (lᵢ, mᵢ) based on the parameter i₁, refer to the formula (1-3) or the formula (1-5). Details are not described herein again.

For example, that the first PMI does not include a parameter i₂ may also mean that CSI that includes the first PMI does not include the parameter i₂.

### (2) Type-1 Multi-Panel Codebook

In the Type-1 multi-panel codebook, two key points are described.

Key point 1: The precoding matrix W includes N_{g} sub-matrixes, that are W=[W₀; . . . ; W_{N}_{_{g}}₋₁], respectively corresponding to N_{g} antenna panels. Each sub-matrix includes R precoding vectors, for example, W_{g}=[w_{g,0}, . . . , w_{N}_{_{g}}_{,R-1}].

In other words, the precoding matrix W includes R precoding vectors wᵢ. Each precoding vector includes N_{g} sub-vectors, that is, the precoding vector satisfies:

wᵢ=[w_{i,0}; w_{i,1}; . . . ; w_{i,N}_{_{g}}₋₁] Formula (8-1)

the sub-vector w_{i,0} is the 1^{st} sub-vector in the precoding vector wᵢ. The sub-vector w_{i,0} is a two-dimensional DFT vector, and the two-dimensional DFT vector satisfies:

$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , ... , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , ... , {e}^{j \frac{2 π {m}_{i} ( {N}_{2} - 1 )}{{O}_{2} {N}_{2}}} ]\end{matrix} \qquad Formula ( 8 - 2 )$$

νₗ_{ᵢ}_{,m}_{ᵢ} represents the two-dimensional DFT vector. (lᵢ, mᵢ) respectively represents an index of the two-dimensional DFT vector in the horizontal dimension and an index of the two-dimensional DFT vector in the vertical dimension, and lᵢ=0,1, . . . , O₁N₁−1, mᵢ=0,1, . . . , O₂N₂−1. O₁ represents an oversampling factor in the horizontal dimension. O₂ represents an oversampling factor in the vertical dimension.

The sub-vector w_{i,g} is the (g+1)^{th} sub-vector in the first precoding vector wᵢ, and the sub-vector w_{i,g} satisfies:

w_{ig}=α_{g}w_{i,0} Formula (8-3)

g=1,2, . . . , N_{g}−1. α_{g} is an offset value of the (g+1)^{th} sub-vector w_{i,g} relative to the 1^{st} sub-vector w_{i,0}.

Key point 2: The first PMI is used to determine (lᵢ, mᵢ) and an offset value α_{g}.

Case 1: for the codebook mode=1, the first PMI includes the parameter i₁, and does not include the parameter i₂.

A process in which the first PMI determines (lᵢ, mᵢ) specifically includes: A value of i₁ satisfies the formula (2-1) and the formula (2-2). In the first PMI, for a process in which i_{1,1} and i_{1,2} determine (lᵢ, mᵢ) or a process in which i_{1,1}, i_{1,2}, and i_{1,3} determine (lᵢ, mᵢ), refer to the formula (1-3). Details are not described herein again.

A process in which the first PMI determines an offset value α_{g} specifically includes: the offset value α_{g} satisfies:

α_{g}=φₚ_{ᵢ} Formula (8-4)

φₚ_{₁} represents a phase rotation of a precoding matrix that is of a (i+1)^{th} antenna panel and that is relative to a precoding matrix of a first antenna panel, and φₚ_{₃} is determined by a parameter i_{1,4} in the first PMI. For details, refer to the formula (2-4), the formula (2-5) and the formula (2-6). Details are not described herein again.

For example, that the first PMI does not include a parameter i₂ may also mean that CSI that includes the first PMI does not include the parameter i₂.

Case 2: For a codebook mode=2, the first PMI includes the parameter i₁ and the parameter i₂. i₂ includes only a part of parameters of an existing feedback parameter i₂.

A process in which the first PMI determines (lᵢ, mᵢ) specifically includes: A value of i₁ satisfies the formula (2-1). In the first PMI, for a process in which i_{1,1} and i_{1,2} determine (lᵢ, mᵢ) or a process in which i_{1,1}, i_{1,2}, and i_{1,3} determine (lᵢ, mᵢ), refer to the formula (1-3). Details are not described herein again. i_{1,4} and i₂ satisfy the following formula:

$$\{ \begin{matrix}{i}_{1 , 4} = {i}_{1 , 4 , 1} \\ {i}_{2} = {i}_{2 , 1}\end{matrix} , \qquad Formula ( 8 - 5 )$$

A process in which the first PMI determines an offset value α_{g} specifically includes: the offset value α_{g} satisfies:

α_{g}=aₚ_{_{g}}bₙ_{_{g}} Formula (8-6)

aₚ_{_{g}}bₙ_{_{g}} represents a rotation phase of a precoding matrix that is in a polarization direction (for example, the polarization direction A) of the (g+1)^{th} antenna panel and that is relative to a precoding matrix in the polarization direction of the first antenna panel. For a calculation formula of aₚ_{_{g}} and bₙ_{_{g}}, refer to the formula (2-9). In the first PMI, i_{1,4,1} and i_{2,1} are used to jointly determine the offset value α_{g}. For details, refer to the descriptions of the formula (2-7), the formula (2-8), and the formula (2-9). Details are not described herein again.

For example, that the first PMI does not include a parameter i_{1,4,2}, i_{2,0}, i_{2,2} may also mean that CSI that includes the first PMI does not include the parameter i_{1,4,2}, i_{2,0}, i_{2,2}.

### (3) Type-2 Codebook

In the Type-2 codebook, two key points are described.

Key point 1: The precoding vector wᵢ is a linear weight of S two-dimensional DFT vectors. For example, the precoding vector wᵢ satisfies:

wᵢ=Σₛ₌₀^{S-1}β_{i,s}νₗ_{ₛ}_{,m}_{ₛ} Formula (9-1)

β_{i,s} is a combination coefficient of the precoding vector wᵢ on the S two-dimensional DFT vectors. νₗ_{ₛ}_{,m}_{ₛ} represents the (s+1)^{th} two-dimensional DFT vector in the S two-dimensional DFT vectors. S is an integer of greater than or equal to 2. S may be predefined in a protocol, or may be notified to a terminal by using signaling after being determined by an access network device. The (s+1)^{th} two-dimensional DFT vector νₗ_{ₛ}_{,m}_{ₛ} satisfies:

$$\{ \begin{matrix}{v}_{{l}_{s} , {m}_{s}} = {[ {u}_{{m}_{s}} , {u}_{{m}_{s}} {e}^{j \frac{2 π {l}_{s}}{{O}_{1} {N}_{1}}} , ... , {u}_{{m}_{s}} {e}^{j \frac{2 π {l}_{s} ( {N}_{1} - 1 )}{{O}_{1} {N}_{1}}} ]}^{T} \\ {u}_{{m}_{s}} = [ 1 , {e}^{j \frac{2 π {m}_{s}}{{O}_{2} {N}_{2}}} , ... , {e}^{j \frac{2 π {m}_{s} ( {N}_{2} - 1 )}{{O}_{2} {N}_{2}}} ]\end{matrix} \qquad Formula ( 9 - 2 )$$

(lₛ, mₛ) respectively represents an index of the (s+1)^{th} two-dimensional DFT vector in the horizontal dimension and an index of the (s+1)^{th} two-dimensional DFT vector in the vertical dimension, and lₛ=0,1, . . . , O₁N₁−1, mₛ=0,1, . . . , O₂N₂−1.

Key point 2: The first PMI is used to determine (lₛ, mₛ) and a combination coefficient β_{i,s}. For example, the first PMI includes i₁ and i₂. A value of i₁ satisfies the formula (3-1), the formula (3-2), and the formula (3-3). A value of i₂ satisfies the formula (3-4). In addition, values of i_{1,1} and i_{1,2} are used to jointly determine (lₛ, mₛ). For details, refer to the formula (3-2) or the formula (3-3). Details are not described herein again. i_{1,3,r}, i_{1,4,r}, i_{2,2,r}, and i_{2,1,r} are reduced from 2S elements to S elements.

i_{1,3,r} represents an index of strongest two-dimensional DFT vectors of the (r+1)^{th} transport stream. A value range of i_{1,3,r} is [0,1, . . . , S−1].

i_{1,4,r}=[k_{r,0}⁽¹⁾, . . . , k_{r,S-1}⁽¹⁾] represents wideband amplitude coefficients p_{i,l}⁽¹⁾ of precoding vectors that are of the (r+1)^{th} transport stream and that are on the S two-dimensional DFT vectors. Each wideband amplitude coefficient is quantized by using three bits.

i_{2,2,r}=[k_{r,0}⁽²⁾, . . . , k_{r,S-1}⁽²⁾] represents subband amplitude coefficients p_{i,l}⁽²⁾ of the precoding vectors that are of the (r+1)^{th} transport stream and that are on the S two-dimensional DFT vectors. Each subband amplitude coefficient is quantized by using one bit.

i_{2,1,r}=[c_{r,0}, . . . , c_{r,S-1}] represents subband phase coefficients φ_{i,l} of the precoding vectors that are of the (r+1)^{th} transport stream and that are on the S two-dimensional DFT vectors. For example, quantization precision of each subband phase coefficient is selected from an N-PSK constellation diagram, and is determined by using the parameter N_{PSK}, where N_{PSK}=4 or N_{PSK}=8.

For example, the precoding vector of the (r+1)^{th} transport stream satisfies:

$${w}_{i} = \frac{1}{\sqrt{{N}_{1} {N}_{2} {\sum }_{l = 0}^{S - 1} {( {p}_{i , l}^{( 1 )} {p}_{i , l}^{( 2 )} )}^{2}}} {\sum }_{l = 0}^{S - 1} {v}_{{l}_{s} , {m}_{s}} {p}_{i , l}^{( 1 )} {p}_{i , l}^{( 2 )} {φ}_{i , l} \qquad Formula ( 9 - 3 )$$

### (4) Type-2 Port Selection Codebook

In the Type-2 port selection codebook, two key points are described.

Key point 1: The precoding vector wᵢ is a linear weight of S unit vectors. For example, the precoding vector wᵢ satisfies:

wᵢ=Σₛ₌₀^{S-1}β_{i,s}νₗ_{ₛ} Formula (10-1)

β_{i,s} is a combination coefficient of the precoding vector wᵢ on the S unit vectors. νₗ_{ₛ} is a column vector with a length of N₁×N₂, where the lₛ+1)^{th} element is 1, and other elements are 0. lₛ represents an index of νₗ_{ₛ} in the S unit vectors, and lₛ=0,1, . . . , S. S is an integer greater than or equal to 2. S may be predefined in a protocol, or may be notified to a terminal by using signaling after being determined by an access network device.

Key point 2: The first PMI is used to determine the index lₛ and the combination coefficient β_{i,s}. For example, the first PMI includes i₁ and i₂. A value of i₁ satisfies the formula (4-1), the formula (3-2), and the formula (3-3). A value of i₂ satisfies the formula (3-4).

In the first PMI, a value of i_{1,1} is used to determine lₛ. For example, a portSelectionSamplingSize parameter d is first determined, where d satisfies d≤min{P_{CSI-RS}, S}. Then, the S unit vectors are determined based on the value of i_{1,1}, where i_{1,1}∈{0,1, . . . , ┌P_{CSI-RS}/d┐}. One of the S unit vectors may be denoted as νᵢ_{_{1,1}}_{d+l}, where l=0,1, . . . , S−1. νᵢ_{_{1,1}}_{d+l} is a vector with a length of P_{CSI-RS}/2. In νᵢ_{_{1,1}}_{d+l}, a value of the (i_{1,1}d+l+1)^{th} element is 1, and values of other elements are 0.

i_{1,3,r}, i_{1,4,r}, i_{2,2,r}, and i_{2,1,r} are reduced from 2S elements to S elements.

i_{1,3,r} represents an index of strongest unit vectors of the (r+1)^{th} transport stream. A value range of i_{1,3,r} is [0,1, . . . , S−1].

i_{1,4,r}=[k_{r,0}⁽¹⁾, . . . , k_{r,S-1}⁽¹⁾] represents wideband amplitude coefficients p_{i,l}⁽¹⁾ of precoding vectors that are of the (r+1)^{th} transport stream and that are on the S unit vectors. Each wideband amplitude coefficient is quantized by using three bits.

i_{2,2,r}=[k_{r,0}⁽²⁾, . . . , k_{r,S-1}⁽²⁾] represents subband amplitude coefficients p_{i,l}⁽²⁾ of the precoding vectors that are of the (r+1)^{th} transport stream and that are on the S unit vectors. Each subband amplitude coefficient is quantized by using one bit.

i_{2,1,r}=[c_{r,0}, . . . , c_{r,S-1}] represents subband phase coefficients φ_{i,l} of the precoding vectors that are of the (r+1)^{th} transport stream and that are on the S unit vectors. For example, quantization precision of each subband phase coefficient is selected from an N-PSK constellation diagram, and is determined by using the parameter N_{PSK}, where N_{PSK}=4, or N_{PSK}=8

For example, the precoding vector of the (r+1)^{th} transport stream satisfies:

$${w}_{i} = \frac{1}{\sqrt{{\sum }_{l = 0}^{S - 1} {( {p}_{i , l}^{( 1 )} {p}_{i , l}^{( 2 )} )}^{2}}} {\sum }_{l = 0}^{S - 1} {v}_{{i}_{1 + 1} d + l} {p}_{i , l}^{( 1 )} {p}_{i , l}^{( 2 )} {φ}_{i , l} \qquad Formula ( 10 - 2 )$$

### (5) Enhanced Type-2 Codebook

In the enhanced Type-2 codebook, the first PMI includes i₁ and i₂. A value of i₁ satisfies the formula (5-1), and a value of i₂ satisfies the formula (5-2). In addition, values of i_{1,1} and i_{1,2} are used to jointly determine S SD base vectors. For details, refer to the formula (3-2) or the formula (3-3). Details are not described herein again. i_{1,6,r} and i_{1,5} are used to determine an index of FD basis vectors of the (r+1)^{th} transport stream. Refer to the descriptions of “A third item is a quantity Mᵣ of FD base vectors of the (r+1)^{th} transport stream”. Details are not described herein again.

i_{1,7,r}, i_{1,8,r}, i_{2,4,r}, and i_{2,5,r} are reduced from 2S elements to S elements.

i_{1,7,r} satisfies:

$$\{ \begin{matrix}{i}_{1 , 7 , r} = [ {k}_{r , 0}^{( 3 )} … {k}_{r , {M}_{r} - 1}^{( 3 )} ] \\ {k}_{r , f}^{( 3 )} = [ {k}_{r , 0 , f}^{( 3 )} … {k}_{r , 2 S - 1 , f}^{( 3 )} ] \\ {k}_{r , l , f}^{( 3 )} ∈ \{ 0 , 1 \} \\ f = [ 0 , 1 , … , {M}_{r} - 1 ]\end{matrix} \qquad Formula ( 11 - 1 )$$

k_{r,l,f}⁽³⁾ indicates a position of an NZ LC coefficient corresponding to a (f+1)^{th} FD base vector and a (l+1)^{th} SD base vector in the (r+1)^{th} transport stream. If k_{r,l,f}⁽³⁾=0, a value of the LC coefficient at the position is 0, and a feedback is not needed. If k_{r,l,f}⁽³⁾=1, a value of the LC coefficient at the position is non-zero, and a feedback is needed.

i_{1,8,r} satisfies:

$${i}_{1 , 8 , r} = \{ \begin{matrix}{\sum }_{l = 0}^{{l}_{1}^{*}} {k}_{1 , l , 0}^{( 3 )} - 1 & R = 1 \\ {l}_{r}^{*} & 1 < R \leq 4\end{matrix} \qquad Formula ( 11 - 2 )$$

lᵣ*∈{0,1, . . . , S−1}.

i_{1,8,r} is used to determine a position of a strongest LC coefficient of each transport

stream (lᵣ*, fᵣ*). fᵣ*=0, and lᵣ*∈{0,1, . . . , S−1}.

i_{2,4,r} satisfies:

$$\{ \begin{matrix}{i}_{2 , 4 , r} = [ {k}_{r , 0}^{( 2 )} … {k}_{r , {M}_{r} - 1}^{( 2 )} ] \\ {k}_{r , f}^{( 2 )} = [ {k}_{r , 0 , f}^{( 2 )} … {k}_{r , S - 1 , f}^{( 2 )} ]\end{matrix} \qquad Formula ( 11 - 3 )$$

A parameter i_{2,5,r} satisfies:

$$\{ \begin{matrix}{i}_{2 , 5 , r} = [ {c}_{r , 0} … {c}_{r , {M}_{r} - 1} ] \\ {c}_{r , f} = [ {c}_{r , 0 , f} … {c}_{r , S - 1 f} ]\end{matrix} \qquad Formula ( 11 - 4 )$$

For example, for a (t+1)^{th} precoding matrix in a frequency domain, a precoding vector of the (i+1)^{th} transport stream is represented as follows:

$$Formula ( 11 - 5 )$$

$${w}_{t , i} = \frac{1}{\sqrt{{γ}_{t , i}}} {\sum }_{l = 0}^{S - 1} {v}_{{m}_{1}^{( l )} , {m}_{2}^{( l )}} {p}_{i , 0}^{( 1 )} {\sum }_{f = 0}^{{M}_{υ}} {y}_{t , i}^{( f )} {p}_{i , l , f}^{( 2 )} {φ}_{i , l , f} ,$$

$${γ}_{t , i} = {\sum }_{l = 0}^{S - 1} {( {p}_{i , l}^{( 1 )} )}^{2} {\vert {{\sum }_{f = 0}}^{{M}_{υ}} {y}_{t , i}^{( f )} {p}_{i , l , f}^{( 2 )} {φ}_{i , l , f} \vert}^{2}$$

$${y}_{t , i}^{( f )} = {e}^{j \frac{2 π {tn}_{3 , i}^{( f )}}{{N}_{3}}}$$

### (6) Enhanced Type-2 Port Selection Codebook

In the enhanced Type-2 port selection codebook, the first PMI includes i₁ and i₂. A value of i₁ satisfies the formula (6-1), and a value of i₂ satisfies the formula (5-2). In addition, i_{1,1} is used to determine S SD unit vectors. For details, refer to the descriptions of the Type-2 port selection codebook. Details are not described herein again. i_{1,6,r} and i_{1,5} are used to determine an index of FD basis vectors of the (r+1)^{th} transport stream. Refer to the descriptions of “A third item is a quantity Mᵣ of FD base vectors of the (r+1)^{th} transport stream”. Details are not described herein again.

i_{1,7,r}, i_{1,8,r}, i_{2,4,r}, and i_{2,5,r} are reduced from 2S elements to S elements.

i_{1,7,r} satisfies:

$$\{ \begin{matrix}{i}_{1 , 7 , r} = [ {k}_{r , 0}^{( 3 )} … {k}_{r , {M}_{r} - 1}^{( 3 )} ] \\ {k}_{r , f}^{( 3 )} = [ {k}_{r , 0 , f}^{( 3 )} … {k}_{r , S - 1 , f}^{( 3 )} ] \\ {k}_{r , l , f}^{( 3 )} ∈ \{ 0 , 1 \} \\ f = [ 0 , 1 , … , {M}_{r} - 1 ]\end{matrix} \qquad Formula ( 12 - 1 )$$

k_{r,l,f}⁽³⁾ indicates a position of an NZ LC coefficient corresponding to a (f+1)^{th} FD base vector and a (l+1)^{th} SD base vector in the (r+1)^{th} transport stream. If k_{r,l,f}⁽³⁾=0, a feedback of the NZ LC coefficient at the position is not needed. If k_{r,l,f}⁽³⁾=1, a feedback of the NZ LC coefficient at the position is needed.

For i_{1,8,r}, refer to the descriptions of the formula (11-2), and details are not described herein again.

i_{2,4,r} satisfies:

$$\{ \begin{matrix}{i}_{2 , 4 , r} = [ {k}_{r , 0}^{( 2 )} … {k}_{r , {M}_{r} - 1}^{( 2 )} ] \\ {k}_{r , f}^{( 2 )} = [ {k}_{r , 0 , f}^{( 2 )} … {k}_{r , S - 1 , f}^{( 2 )} ]\end{matrix} \qquad Formula ( 12 - 2 )$$

The parameter i_{2,5,r} satisfies:

$$\{ \begin{matrix}{i}_{2 , 5 , r} = [ {c}_{r , 0} … {c}_{r , {M}_{r} - 1} ] \\ {c}_{r , f} = [ {c}_{r , 0 , f} … {c}_{r , S - 1 , f} ]\end{matrix} \qquad Formula ( 12 - 3 )$$

For example, for the ((t+1))^{th} precoding matrix in a frequency domain, a precoding vector of the ((r+1))^{th} transport stream is represented as follows:

$$Formula ( 12 - 4 )$$

$${w}_{t , i} = \frac{1}{\sqrt{{γ}_{t , i}}} {\sum }_{l = 0}^{S - 1} {v}_{{i}_{1 , 1} d + l} {p}_{i , 0}^{( 1 )} {\sum }_{f = 0}^{{M}_{r}} {y}_{t , i}^{( f )} {p}_{i , l , f}^{( 2 )} {φ}_{i , l , f}$$

$${γ}_{t , i} = {\sum }_{l = 0}^{S - 1} {( {p}_{i , l}^{( 1 )} )}^{2} {\vert {\sum }_{f = 0}^{{M}_{r}} {y}_{t , i}^{( f )} {p}_{i , l , f}^{( 2 )} {φ}_{i , l , f} \vert}^{2} ,$$

$$and$$

$${y}_{t , i}^{( f )} = {e}^{j \frac{2 π {tn}_{3 , i}^{( f )}}{{N}_{3}}} .$$

The foregoing uses six types of codebooks as examples to describe the first PMI that matches a single-polarized antenna port.

For example, before the terminal determines the first PMI, RS measurement is performed to determine a channel measurement result and an interference measurement result (or determine a channel measurement result and a noise measurement result). The terminal determines the first PMI based on the channel measurement result and the interference measurement result (or the channel measurement result and the noise measurement result).

For example, before the terminal determines the first PMI, the terminal first determines a codebook type. The terminal determines the first PMI based on the codebook type. For example, when the codebook type is a Type-1 single panel codebook, the terminal determines a precoding matrix based on the foregoing descriptions of the Type-1 single panel codebook. For determining of the codebook type, refer to descriptions of PMI feedback configuration information in S205. Details are not described herein.

In some embodiments, the first PMI is carried in a first CSI report. The first CSI report does not include a second PMI. The first PMI and the second PMI jointly indicate a precoding matrix W_{dual}. The precoding matrix W_{dual} includes R precoding vectors w_{dual,i}=[wᵢ, \tilde{w}ᵢ], and i=0,1,2, . . . , R−1. The precoding vectors wᵢ and \tilde{w}ᵢ are column vectors with the length of N₁×N₂×N_{g}. The precoding vector wᵢ represents a precoding vector in a first polarization direction. The precoding vector \tilde{w}ᵢ represents a precoding vector in a second polarization direction. In other words, the first CSI report corresponds to one piece of CSI. The piece of CSI includes the first PMI, and does not include the second PMI. The second PMI is described as follows: The second PMI includes a parameter used to determine the precoding matrix. For example, when the codebook is the Type-1 single panel codebook, the second PMI includes the parameter i₂. The precoding matrix W_{dual} jointly indicated by the first PMI and the second PMI is shown in Table 1-1 or Table 1-2. Alternatively, when the codebook is the codebook mode 1 of the Type-1 multi-panel codebook, the second PMI includes the parameter i₂. The precoding matrix W_{dual} jointly indicated by the first PMI and the second PMI is shown in Table 2-1. It should be understood that the codebook may be further implemented as the Type-2 codebook, the Type-2 port selection codebook, the enhanced Type-2 codebook, or the enhanced Type-2 port selection codebook. A case in which the first PMI and the second PMI jointly indicate the precoding matrix W_{dual} is not listed one by one herein.

S202: The terminal sends the first PMI to the access network device. Correspondingly, the access network device receives the first PMI from the terminal.

For example, the first PMI is carried in the first CSI report. The terminal sends the first CSI report carrying the first PMI to the access network device. Correspondingly, the access network device receives the first CSI report carrying the first PMI from the terminal. Optionally, the first CSI report further includes a first RI and a first CQI. The first RI, the first PMI, and the first CQI correspond to one channel/interference measurement result.

For another example, the terminal sends the first PMI to the access network device on a PUCCH (or a PUSCH). Correspondingly, the access network device receives the first PMI from the terminal on the PUCCH (or the PUSCH). All parameters in the first PMI may be jointly fed back. To be specific, after bit information of all the parameters in the first PMI are connected in series, channel coding and transmission is performed. Alternatively, all parameters in the first PMI may be independently fed back. For example, when the first PMI includes i₁ and i₂, channel coding and transmission are separately performed on i₁ and i₂.

S203: The access network device performs precoding based on the precoding matrix W indicated by the first PMI.

For example, when the access network device determines to transmit downlink data by using the single-polarized antenna array, the access network device restores the precoding matrix W based on the first PMI, and performs precoding on the to-be-transmitted data with reference to the precoding matrix W.

In the precoding matrix indicator feedback method 200 according to an embodiment of this application, the precoding matrix W indicated by the first PMI includes R precoding vectors wᵢ, and the precoding vector wᵢ is a column vector with a length of N₁×N₂×N_{g}. In other words, the precoding matrix W indicated by the first PMI includes a precoding vector in a polarization direction, and matches an antenna array in a single-polarized design. In this way, the terminal can feed back, to the access network device, the first PMI that matches the single-polarized antenna array.

In some embodiments, as shown in FIG. 2, the precoding matrix indicator feedback method 200 according to an embodiment of this application may further include S204 or S205.

S204: The access network device sends first configuration information to the terminal. Correspondingly, the terminal receives the first configuration information from the access network device.

The first configuration information indicates that a quantity of ports of an RS is N₁×N₂×N_{g}. The measurement result of the RS is used to determine the first PMI.

For example, the first configuration information may be reference signal configuration information. The reference signal configuration information is associated with CSI report configuration information.

In other words, the first configuration information indicates a single-polarized PMI feedback manner by indicating an RS port configuration. In this case, the terminal provides the first PMI determined based on the single-polarized PMI feedback manner.

S205: The access network device sends first indication information to the terminal. Correspondingly, the terminal receives the first indication information from the access network device.

The first indication information indicates the single-polarized PMI feedback manner. The single-polarized PMI feedback manner indicated by the first indication information is used to determine the first PMI.

For example, the first indication information may be an information element in codebook configuration information. The codebook configuration information is carried in the CSI report configuration information.

In other words, the first indication information clearly indicates the single-polarized PMI feedback manner. After the terminal determines a single-polarized first PMI, the terminal feeds back the single-polarized first PMI to the access network device.

It should be noted that S204 and S205 are optional steps, as shown in two dashed-line boxes in FIG. 2. When the terminal can feed back both a PMI that matches a dual-polarized antenna array and a PMI that matches the single-polarized antenna array, the terminal may perform S204 before performing S201. In this case, the terminal does not perform S205. Alternatively, the terminal may perform S205 before performing S201. In this case, the terminal does not perform S204. It should be understood that, when the terminal performs S205, the quantity of ports of the reference signal may be N₁×N₂×N_{g}, and may also be 2×N₁×N₂×N_{g}. This is not limited by embodiments of this application.

In addition, the CSI report configuration information (or the reference signal configuration information) further includes the PMI feedback configuration information. The PMI feedback configuration information may include the following three items:

A first item is antenna port deployment information. For example, the first item may include a quantity of antenna panels N_{g}, a quantity N₁ of H-dimensional ports on each antenna panel, a quantity N₂ of V-dimensional ports on each antenna panel, an H-dimensional oversampling factor O₁ during precoding matrix construction, and a V-dimensional oversampling factor O₂ during precoding matrix construction, and the like.

A second item is a deployment manner of the antenna panel. For example, the second item may be represented as N_{g,H}×N_{g,v}·N_{g,H} is a quantity of antenna panels in the horizontal dimension, and N_{g,V} represents a quantity of antenna panels in the vertical dimension. For example, when there are four antenna panels, the deployment manner may be deployed in a horizontal deployment manner of 4*1, a vertical deployment manner of 1*4, or a rectangular deployment manner of 2*2.

A third item indicates a port polarization deployment manner. For example, the third item may indicate whether a port is deployed in a single-polarized manner or deployed in a dual-polarized manner. Further, when the port is deployed in dual-polarized mode, two polarization directions may be indicated, for example, the two polarization directions are (00, 900) or (+450, −450) respectively.

Optionally, the PMI feedback configuration information further includes the codebook configuration information. The codebook configuration information indicates the codebook type. For example, the codebook configuration information may indicate the Type-1 single panel codebook, the Type-1 multi-panel codebook, the Type-2 codebook, the Type-2 port selection codebook, the enhanced Type-2 codebook, or the enhanced Type-2 port selection codebook.

Optionally, the PMI feedback information further includes base vector quantity information.

In some embodiments, the CSI report configuration information further includes third indication information. The third indication information indicates a dual-polarized PMI feedback manner. The dual-polarized PMI feedback manner indicated by the third indication information is used to feed back a third PMI. In other words, the access network device includes two pieces of indication information, that is first indication information and third indication information, in a same piece of CSI report configuration information, to indicate that the terminal feeds back both the first PMI that matches the single-polarized antenna array and the third PMI that matches the dual-polarized antenna array in a same CSI report. For details, refer to descriptions in S207. Details are not described herein.

In some embodiments, as shown in FIG. 2, when S205 is performed, the precoding matrix indicator feedback method 200 according to an embodiment of this application may further include S206.

S206: The access network device sends second indication information to the terminal. Correspondingly, the terminal receives the second indication information from the access network device.

The second indication information indicates the polarization direction. The polarization direction indicated by the second indication information is used to determine the first PMI.

For example, when the reference signal is deployed on a dual-polarized port, the second indication information may be active pattern set configuration information. The active pattern set configuration information indicates port activation states in the H dimension, the V dimension, and a polarization dimension.

For example, when the reference signal is a single panel reference signal, the active pattern set configuration information is indicated by using a three-dimensional bitmap matrix. For example, the three-dimensional bitmap matrix satisfies:

$$\{ \begin{matrix}C = [ {C}_{x , y , z} ] \\ x = 0 , 1 , … , {N}_{1} - 1 \\ x = 0 , 1 , … , {N}_{1} - 1 \\ p = 0 , 1\end{matrix} \qquad Formula ( 13 - 1 )$$

C represents the three-dimensional bitmap matrix. C_{x,y,z} represents port activation states in the (x+1)^{th} row, the (y+1)^{th} column, and the (p+1)^{th} polarization direction. For example, C_{x,y,z}=1 represents an activated state, and C_{x,y,z}=0 represents a deactivated state. Alternatively, on the contrary, C_{x,y,z}=1 represents the deactivated state, and C_{x,y,z}=0 represents the activated state. In an example in which C_{x,y,z}=1 represents the activated state, the second indication information includes C_{x,y,0}=1, to indicate an activated port in the first polarization direction. The terminal needs to feed back the first PMI that matches the first polarization direction. Alternatively, the second indication information includes C_{x,y,1}=1, to indicate an activated port in the second polarization direction. The terminal needs to feed back the first PMI that matches the second polarization direction. For example, the first polarization direction may be the polarization direction A, and the second polarization direction may be the polarization direction B. Alternatively, the first polarization direction may be the foregoing polarization direction B, and the second polarization direction may be the foregoing polarization direction A.

When the reference signal is a multi-panel reference signal, the active pattern set configuration information is indicated by using a four-dimensional bitmap matrix. For example, the four-dimensional bitmap matrix satisfies:

$$\{ \begin{matrix}D = [ {D}_{g , x , y , z} ] \\ g = 1 , 2 , … , {N}_{g} - 1 \\ x = 0 , 1 , … , {N}_{1} - 1 \\ y = 0 , 1 , … , {N}_{1} - 1 \\ p = 0 , 1\end{matrix} \qquad Formula ( 13 - 2 )$$

D represents the four-dimensional bitmap matrix. D_{g,x,y,z} represents port activation states in the (g+1)^{th} antenna panel, the (x+1)^{th} row, the (y+1)^{th} column, and the (p+1)^{th} polarization direction. For example, D_{g,x,y,z}=1 represents an activated state, and D_{g,x,y,z}=0 represents a deactivated state. Alternatively, on the contrary, D_{g,x,y,z}=1 represents the deactivated state, and D_{g,x,y,z}=0 represents the activated state. In an example in which D_{g,x,y,z}=1 represents the activated state, the second indication information includes D_{g,x,y,0}=1, to indicate an activated port in the first polarization direction of the (g+1)^{th} antenna panel. The terminal needs to feed back the first PMI that matches the first polarization direction. Alternatively, the second indication information includes D_{g,x,y,1}=1, to indicate an activated port in the second polarization direction of the (g+1)^{th} antenna panel. The terminal needs to feed back the first PMI that matches the second polarization direction.

It should be noted that S206 is an optional step. For example, when the terminal is defaulted to feed back a PMI that matches a polarization direction, the terminal may not perform S206, but perform S201. The polarization direction that is fed back by default may be predefined in a protocol, for example, the polarization direction A or the polarization direction B. For another example, when the terminal can feed back both a PMI that matches the polarization direction A, and a PMI that matches the polarization direction B, the terminal may perform S206 before performing S201. For example, when the quantity of ports of the reference signal is 2×N₁×N₂×N_{g}, the terminal performs S206 before performing S201.

It should be understood that, when the terminal performs S205 and S206, the terminal may perform S205 before performing S206, or may perform S206 before performing S205, or may simultaneously perform S205 and S206. Further, when the terminal simultaneously performs S205 and S206, the first indication information and the second indication information may be carried in a same message, or may be carried in different messages. This is not limited in embodiments of this application.

In some embodiments, the precoding matrix indicator feedback method 200 according to an embodiment of this application may further include the following step: The terminal sends the third PMI to the access network device. Correspondingly, the access network device receives the third PMI from the terminal.

The third PMI indicates a precoding matrix W′_{dual}. The precoding matrix W′_{dual} includes R′_{dual} precoding vectors w′_{dual,i}, and i=0,1,2, . . . , R′_{dual}−1. The precoding vector w′_{dual,i} is a column vector with a length of 2×N₁×N₂×N_{g}. For example, when the codebook is the Type-1 single panel codebook, the third PMI includes the parameters i₁ and i₂. A precoding matrix W′_{dual} indicated by the third PMI is shown in Table 1-1 or Table 1-2. For details, refer to the descriptions of the Type-1 single panel codebook in the term explanation part. It should be understood that the codebook may be further implemented as the Type-1 multi-panel codebook, the Type-2 codebook, the Type-2 port selection codebook, the enhanced Type-2 codebook, or the enhanced Type-2 port selection codebook. Cases of the third PMI and cases in which the third PMI indicates the precoding matrix W′_{dual} are not listed one by one. For details, refer to descriptions of the codebook in the term explanation part. Details are not described herein again.

The third PMI and the first PMI belong to different CSI. This may be specifically understood as follows: The precoding matrix indicated by the third PMI and the precoding matrix indicated by the first PMI correspond to different downlink frequency domain resources.

For example, the third PMI and the first PMI may be carried in different CSI reports. For example, when one CSI report corresponds to one port activation pattern, or one CSI report corresponds to one piece of CSI, a CSI report carrying the third PMI and a CSI report carrying the first PMI are different.

Alternatively, the third PMI and the first PMI may also be carried in a same CSI report. For example, when one CSI report corresponds to at least two port activation patterns, or one CSI report corresponds to one piece of CSI, a CSI report carrying the third PMI and a CSI report carrying the first PMI are the same. The same CSI report carries both the first PMI that matches the single-polarized antenna array and the third PMI that matches the dual-polarized antenna array, to reduce signaling overheads.

It is easy to understand that, when the access network device determines to transmit the downlink data by using the dual-polarized antenna array, after the access network device receives the third PMI, the access network device performs precoding processing based on the precoding matrix W′_{dual} indicated by the third PMI.

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

It may be understood that to implement functions in the foregoing embodiments, the base station and the terminal include corresponding hardware structures and/or software modules for performing various functions. A person skilled in the art should be easily aware that, in combination with the units and the method steps in the examples described in embodiments disclosed in this application, this application can be implemented by using hardware or a combination of hardware and computer software. Whether a function is performed by using hardware or hardware driven by computer software depends on a particular application scenario and design constraint of the technical solutions.

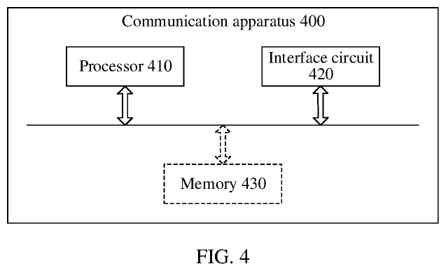

FIG. 3 and FIG. 4 are schematic diagrams of structures of possible communication apparatuses according to embodiments of this application. The communication apparatus may be configured to implement functions of the terminal or the access network device in the foregoing method embodiments. Therefore, beneficial effects of the foregoing method embodiments can also be achieved. In embodiments of this application, the communication apparatus may be one of the terminals 120a to 120j shown in FIG. 1, or may be the access network device 110a or 110b shown in FIG. 1, or may be a module (such as a chip) used in the terminal or the access network device.

As shown in FIG. 3, a communication apparatus 300 includes a processing unit 310 and a transceiver unit 320. The communication apparatus 300 is configured to implement a function of the terminal or the access network device according to the method embodiment shown in FIG. 2.

When the communication apparatus 300 is configured to implement a function of the terminal in a method embodiment shown in FIG. 2, the transceiver unit 320 is configured to perform S202, S204, S205, and S206. The processing unit 310 is configured to perform S201.

When the communication apparatus 300 is configured to implement the function of the access network device in a method embodiment shown in FIG. 2, the transceiver unit 320 is configured to perform S202, S204, S205, and S206. The processing unit 310 is configured to perform S203.

For more detailed descriptions of the processing unit 310 and the transceiver unit 320, directly refer to related descriptions of the method embodiment shown in FIG. 2. Details are not described herein again.

All related content of the steps in the foregoing method embodiments may be cited in function descriptions of the corresponding functional modules. Details are not described herein again.

As shown in FIG. 4, a communication apparatus 400 includes a processor 410 and an interface circuit 420. The processor 410 and the interface circuit 420 are coupled to each other. It may be understood that the interface circuit 420 may be a transceiver or an input/output interface. Optionally, the communication apparatus 400 may further include a memory 430, configured to store instructions to be executed by the processor 410, store input data required for running the instructions by the processor 410, or store data generated after the processor 410 runs the instructions.

When the communication apparatus 400 is configured to implement the method shown in FIG. 2, the processor 410 is configured to perform a function of the processing unit 310. The interface circuit 420 is configured to perform a function of the transceiver unit 320.

When the foregoing communication apparatus is a chip used in the terminal, the terminal chip implements a function of the terminal in the foregoing method embodiments. The terminal chip receives information from another module (for example, a radio frequency module or an antenna) in the terminal. The information is sent by the access network device to the terminal. Alternatively, the chip in the terminal sends information to another module (for example, a radio frequency module or an antenna) in the terminal. The information is sent by the terminal to the access network device.

When the communication apparatus is a module used in the access network device, the module in the access network device implements a function of the access network device in the foregoing method embodiments. The module in the access network device receives information from another module (for example, the radio frequency module or the antenna) in the access network device. The information is sent by the terminal device to the access network device. Alternatively, the module in the access network device sends information to another module (for example, the radio frequency module or the antenna) in the access network device. The information is sent by the access network device to a terminal device. The access network device module herein may be a baseband chip of the access network device, or may be a DU or another module. The DU herein may be a DU in an open radio access network (O-RAN) architecture.

It can be understood that the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general purpose processor may be a microprocessor or any regular processor or the like.

The method steps in embodiments of this application may be implemented in a hardware manner, or may be implemented in a manner of executing software instructions by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to a processor, so that the processor can read information from the storage medium and write information into the storage medium. Certainly, the storage medium may be a component of the processor. The processor and the storage medium may be disposed in an ASIC. In addition, the ASIC may be located in an access network device or a terminal. Certainly, the processor and the storage medium may exist in the access network device or the terminal as discrete components.

All or some of the foregoing embodiments may be implemented by using software, hardware, firmware, or any combination thereof. When software is used to implement the foregoing embodiments, all or some of the foregoing embodiments may be implemented in a form of a computer program product. The computer program product includes one or more computer programs and instructions. When the computer programs or instructions are loaded and executed on a computer, all or some of the procedures or functions in embodiments of this application are performed. The computer may be a general-purpose computer, a dedicated computer, a computer network, a network device, user equipment, or another programmable apparatus. The computer programs or instructions may be stored in a computer-readable storage medium, or may be transmitted from a computer-readable storage medium to another computer-readable storage medium. For example, the computer programs or instructions may be transmitted from a website, computer, server, or data center to another website, computer, server, or data center in a wired manner or in a wireless manner. The computer-readable storage medium may be any usable medium that can be accessed by the computer, or a data storage device, such as a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or nonvolatile storage medium, or may include two types of storage media: a volatile storage medium and a non-volatile storage medium.

In various embodiments of this application, unless otherwise stated or there is a logic conflict, terms and/or descriptions in different embodiments are consistent and may be mutually referenced, and technical features in different embodiments may be combined based on an internal logical relationship thereof, to form a new embodiment.

In this application, “at least one” refers to one or more. “And/or” is an association relationship for describing associated objects, and indicates that three relationships may exist. For example, A and/or B may indicate the following cases: Only A exists, both A and B exist, and only B exists, where A and B may be in a singular form or a plural form. In a formula of this application, the character “/” indicates a “division” relationship between associated objects. “Including at least one of A, B, and C” may represent: including A; including B; including C; including A and B; including A and C; including B and C; and including A, B, and C.

It may be understood that various numbers in embodiments of this application are merely used for differentiation for ease of description, and are not used to limit the scope of embodiments of this application. The sequence numbers of the foregoing processes do not mean execution sequences, and the execution sequences of the processes should be determined based on functions and internal logic of the processes.

What is claimed is:

1. A method, comprising:
determining a first precoding matrix indicator (PMI), wherein the first PMI indicates a precoding matrix W, the precoding matrix W comprises R precoding vectors wᵢ, i=0,1,2, . . . , R−1, the precoding vector wᵢ is a column vector with a length of N₁×N₂×N_{g}, N_{g} represents a quantity of antenna panels, N₁ represents a quantity of ports in a first dimension on one antenna panel, N₂ represents a quantity of ports in a second dimension on the antenna panel, N₁, N₂, and N_{g} are all positive integers, and at least one of N₁, N₂, and N_{g} is greater than or equal to 2; and
sending the first PMI.

2. The method according to claim 1, wherein the method further comprises:
receiving first indication information, wherein the first indication information indicates a single-polarized PMI feedback manner, and the single-polarized PMI feedback manner is used to determine the first PMI.

3. The method according to claim 2, wherein the method further comprises:
receiving second indication information, wherein the second indication information indicates a polarization direction, and the polarization direction is used to determine the first PMI.

4. The method according to claim 1, wherein N_{g}=1, the precoding vector wᵢ is a two-dimensional discrete Fourier transform (DFT) vector, and the two-dimensional DFT vector satisfies:
$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix} ,$$
wherein
νₗ_{ᵢ}_{,m}_{ᵢ} represents the two-dimensional DFT vector; (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1; O₁ represents an oversampling factor in the first dimension; and O₂ represents an oversampling factor in the second dimension, wherein
the first PMI is used to determine (lᵢ, mᵢ).

5. The method according to claim 1, wherein N_{g}>1, and the precoding vector wᵢ satisfies:
wᵢ≤[w_{i,0}; w_{i,1}; . . . ; w_{i,N}_{_{g}}₋₁], wherein
the sub-vector w_{i,0} is the 1^{st} sub-vector in the precoding vector wᵢ; and the sub-vector w_{i,0} is a two-dimensional DFT vector, and the two-dimensional DFT vector satisfies:
$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix} ,$$
wherein
νₗ_{ᵢ}_{,m}_{ᵢ} represents the two-dimensional DFT vector, (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1; O₁ represents an oversampling factor in the first dimension; and O₂ represents an oversampling factor in the second dimension; and
the sub-vector w_{i,g} is the (g+1)^{th} sub-vector in the precoding vector wᵢ, and the sub-vector w_{i,g} satisfies:
w_{i,g}=α_{g}w_{i,0}, wherein
g=1,2, . . . , N_{g}−1, and α_{g} is an offset value of the (g+1)^{th} sub-vector w_{i,g} relative to the 1^{st} sub-vector w_{i,0}, wherein
the first PMI is used to determine (lᵢ, mᵢ) and the offset value α_{g}.

6. The method according to claim 1, wherein the first PMI is carried in a first channel state information (CSI) report, the first CSI report does not comprise a second PMI, the second PMI and the first PMI jointly indicate a precoding matrix W_{dual}, the precoding matrix W_{dual} comprises R precoding vectors w_{dual,i}, w_{dual,i}=[wᵢ, \tilde{w}ᵢ], and i=0,1,2, . . . , R−1, wherein the precoding vectors wᵢ and \tilde{w}ᵢ are column vectors with a length of N₁×N₂×N_{g}, the precoding vector wᵢ represents a precoding vector in a first polarization direction, and the precoding vector \tilde{w}ᵢ represents a precoding vector in a second polarization direction.

7. The method according to claim 1, wherein the first PMI is carried in a first CSI report, the first PMI is a single-polarized PMI, the first CSI report further comprises a third PMI, the third PMI is a dual-polarized PMI, the third PMI indicates a precoding matrix W′_{dual}, the precoding matrix W′_{dual} comprises R′_{dual} precoding vectors w′_{dual,i}, i=0,1,2, . . . , R′_{dual}−1, and the precoding vector w′_{dual,i} is a column vector with a length of 2×N₁×N₂×N_{g}.

8. An apparatus, comprising:
at least one processor coupled to one or more memories storing programming instructions for execution by the at least one processor to perform operations comprising:
determining a first precoding matrix indicator (PMI), wherein the first PMI indicates a precoding matrix W, the precoding matrix W comprises R precoding vectors wᵢ, i=0,1,2, . . . , R−1, the precoding vector wᵢ is a column vector with a length of N₁×N₂×N_{g}, N_{g} represents a quantity of antenna panels, N₁ represents a quantity of ports in a first dimension on one antenna panel, N₂ represents a quantity of ports in a second dimension on the antenna panel, N₁, N₂, and N_{g} are all positive integers, and at least one of N₁, N₂, and N_{g} is greater than or equal to 2; and
sending the first PMI.

9. The apparatus according to claim 8, wherein the operations further comprises:
receiving first indication information, wherein the first indication information indicates a single-polarized PMI feedback manner, and the single-polarized PMI feedback manner is used to determine the first PMI.

10. The apparatus according to claim 9, wherein the operations further comprises:
receiving second indication information, wherein the second indication information indicates a polarization direction, and the polarization direction is used to determine the first PMI.

11. The apparatus according to claim 8, wherein N_{g}=1, the precoding vector wᵢ is a two-dimensional discrete Fourier transform (DFT) vector, and the two-dimensional DFT vector satisfies:
$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix} ,$$
wherein
νₗ_{ᵢ}_{,m}_{ᵢ} represents the two-dimensional DFT vector; (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1; O₁ represents an oversampling factor in the first dimension; and O₂ represents an oversampling factor in the second dimension, wherein
the first PMI is used to determine (lᵢ, mᵢ).

12. The apparatus according to claim 8, wherein N_{g}>1, and the precoding vector wᵢ satisfies:
wᵢ=[w_{i,0}; w_{i,1}; . . . ; w_{i,N}_{_{g}}₋₁], wherein
the sub-vector w_{i,0} is the 1^{st} sub-vector in the precoding vector wᵢ; and the sub-vector w_{i,0} is a two-dimensional DFT vector, and the two-dimensional DFT vector satisfies:
$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix} ,$$
wherein
νₗ_{ᵢ}_{,m}_{ᵢ} represents the two-dimensional DFT vector, (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1; O₁ represents an oversampling factor in the first dimension; and O₂ represents an oversampling factor in the second dimension; and
the sub-vector w_{i,g} is the (g+1)^{th} sub-vector in the precoding vector wᵢ, and the sub-vector w_{i,g} satisfies:
w_{i,g}=α_{g}w_{i,0}, wherein
g=1,2, . . . , N_{g}−1, and α_{g} is an offset value of the (g+1)^{th} sub-vector w_{i,g} relative to the 1^{st} sub-vector w_{i,0}, wherein
the first PMI is used to determine (lᵢ, mᵢ) and the offset value α_{g}.

13. The apparatus according to claim 8, wherein the first PMI is carried in a first channel state information (CSI) report, the first CSI report does not comprise a second PMI, the second PMI and the first PMI jointly indicate a precoding matrix W_{dual}, the precoding matrix W_{dual} comprises R precoding vectors w_{dual,i}, w_{dual,i}=[wᵢ, \tilde{w}ᵢ], and i=0,1,2, . . . , R−1, wherein the precoding vectors wᵢ and \tilde{w}ᵢ are column vectors with a length of N₁×N₂×N_{g}, the precoding vector wᵢ represents a precoding vector in a first polarization direction, and the precoding vector \tilde{w}ᵢ represents a precoding vector in a second polarization direction.

14. The apparatus according to claim 8, wherein the first PMI is carried in a first CSI report, the first PMI is a single-polarized PMI, the first CSI report further comprises a third PMI, the third PMI is a dual-polarized PMI, the third PMI indicates a precoding matrix W′_{dual}, the precoding matrix W′_{dual} comprises R′_{dual} precoding vectors w′_{dual,i}, i=0,1,2, . . . , R′_{dual}−1, and the precoding vector w′_{dual,i} is a column vector with a length of 2×N₁×N₂×N_{g}.

15. An apparatus, comprising:
at least one processor coupled to one or more memories storing programming instructions for execution by the at least one processor to perform operations comprising:
receiving a first precoding matrix indicator (PMI), wherein the first PMI indicates a precoding matrix W, the precoding matrix W comprises R precoding vectors wᵢ, i=0,1,2, . . . , R−1, the precoding vector wᵢ is a column vector with a length of N₁×N₂×N_{g}, N_{g} represents a quantity of antenna panels, N₁ represents a quantity of ports in a first dimension on one antenna panel, N₂ represents a quantity of ports in a second dimension on the antenna panel, N₁, N₂, and N_{g} are all positive integers, and at least one of N₁, N₂, and N_{g} is greater than or equal to 2; and
performing precoding based on the precoding matrix W indicated by the first PMI.

16. The apparatus according to claim 15, wherein the operations further comprises:
sending first indication information, wherein the first indication information indicates a single-polarized PMI feedback manner, and the single-polarized PMI feedback manner is used to determine the first PMI.

17. The apparatus according to claim 16, wherein the operations further comprises:
sending second indication information, wherein the second indication information indicates a polarization direction, and the polarization direction is used to determine the first PMI.

18. The apparatus according to claim 15, wherein N_{g}=1, the precoding vector wᵢ is a two-dimensional discrete Fourier transform (DFT) vector, and the two-dimensional DFT vector satisfies:
$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix} ,$$
wherein
νₗ_{ᵢ}_{,m}_{ᵢ} represents the two-dimensional DFT vector, (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1; O₁ represents an oversampling factor in the first dimension; and O₂ represents an oversampling factor in the second dimension, wherein
the first PMI is used to determine (lᵢ, mᵢ).

19. The apparatus according to claim 15, wherein N_{g}>1, and the precoding vector wᵢ satisfies:
wᵢ=[w_{i,0}; w_{i,1}; . . . ; w_{i,N}_{_{g}}₋₁], wherein
the sub-vector w_{i,0} is the 1^{st} sub-vector in the precoding vector wᵢ, the sub-vector w_{i,0} is a two-dimensional DFT vector, and the two-dimensional DFT vector satisfies:
$$\{ \begin{matrix}{v}_{{l}_{i} , {m}_{i}} = {[ {u}_{{m}_{i}} , {u}_{{m}_{i}} {e}^{j \frac{2 π {l}_{i}}{{O}_{1} {N}_{1}}} , … , {u}_{{m}_{i}} {e}^{j \frac{2 π {l}_{i} ( {N}_{1} - 1 )}{{O}_{1} {N}_{1}}} ]}^{T} \\ {u}_{{m}_{i}} = [ 1 , {e}^{j \frac{2 π {m}_{i}}{{O}_{2} {N}_{2}}} , … , {e}^{j \frac{2 π {m}_{i} ( {N}_{2} - 1 )}{{O}_{2} {N}_{2}}} ]\end{matrix} ,$$
wherein
νₗ_{ᵢ}_{,m}_{ᵢ} represents the two-dimensional DFT vector, (lᵢ, mᵢ) respectively represents an index of the two-dimensional DFT vector in the first dimension and an index of the two-dimensional DFT vector in the second dimension, lᵢ=0,1, . . . , O₁N₁−1, and mᵢ=0,1, . . . , O₂N₂−1; O₁ represents an oversampling factor in the first dimension; and O₂ represents an oversampling factor in the second dimension; and
the sub-vector w_{i,g} is the (g+1)^{th} sub-vector in the precoding vector wᵢ, and the sub-vector w_{i,g} satisfies:
w_{i,g}=α_{g}w_{i,0}, wherein
g=1,2, . . . , N_{g}−1, and α_{g} is an offset value of the (g+1)^{th} sub-vector w_{i,g} relative to the 1^{st} sub-vector w_{i,0}, wherein
the first PMI is used to determine (lᵢ, mᵢ) and the offset value α_{g}.

20. The apparatus according to claim 15, wherein the first PMI is carried in a first channel state information (CSI) report, the first CSI report does not comprise a second PMI, the second PMI and the first PMI jointly indicate a precoding matrix W_{dual}, the precoding matrix W_{dual} comprises R precoding vectors w_{dual,i}, w_{dual,i}=[wᵢ, \tilde{w}ᵢ], and i=0,1,2, . . . , R−1, wherein the precoding vectors wᵢ and \tilde{w}ᵢ are column vectors with a length of N₁×N₂×N_{g}, the precoding vector wᵢ represents a precoding vector in a first polarization direction, and the precoding vector \tilde{w}ᵢ represents a precoding vector in a second polarization direction.
